(19) United States
(12) Patent Application Publication
(10) Pub. No.: US 2024/0237038 A1
(43) Pub. Date: Jul. 11, 2024

(54) CONTENTION-BASED SCHEDULING REQUEST RESOURCES

(71) Applicant: QUALCOMM Incorporated, San Diego, CA (US)

(72) Inventors: Diana Maamari, San Diego, CA (US); Ahmed Elshafie, San Diego, CA (US); Prashanth Haridas Hande, San Diego, CA (US); Mickael Mondet, Louannec (FR); Ozcan Ozturk, San Diego, CA (US); Huilin Xu, Temecula, CA (US); Hyun Yong Lee, San Diego, CA (US); Chih-Ping Li, San Diego, CA (US)

(21) Appl. No.: 18/152,099

(22) Filed: Jan. 9, 2023

(51) Int. Cl. H04W 72/52; H04W 72/21; H04W 72/543; H04W 74/08

(52) U.S. Cl. CPC H04W 72/52; H04W 72/21; H04W 72/543; H04W 74/08

(57) ABSTRACT

Methods, systems, and devices for wireless communications are described. A user equipment (UE) may receive a message indicating multiple contention-based resource sets dedicated for the transmission of scheduling requests, where each contention-based resource set is associated with one or more respective contentions. The one or more respective conditions may be associated with a packet delay threshold, a buffer size threshold, or a probability function. The UE may transmit a scheduling request to request uplink resources for the UE using a resource of a contention-based resource set based on satisfaction of the one or more respective conditions of the contention-based resource set. In some examples, a remaining packet delay budget of an uplink message at the UE may satisfy the packet delay threshold of the contention-resource set. As such, the UE may randomly select the resource, from the contention-based resource set, to use for transmission of the scheduling request.

### FIELD OF TECHNOLOGY

The following relates to wireless communications, including contention-based scheduling request resources.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support contention-based scheduling request resources. For example, the described techniques provide for a network entity to configure multiple user equipments (UEs) with multiple contention-based resource sets (e.g., shared resource sets) for transmission of scheduling requests. For example, the network entity may transmit, to one or more UEs, a message indicating multiple contention-based resource sets, where each contention-based resource set is associated with one or more respective conditions. As such, a UE of the multiple UEs may transmit a scheduling request using a resource of a contention-based resource set based on satisfying one or more conditions associated with the contention-based resource set and successful completion of a contention-based procedure.

A method for wireless communication at a UE is described. The method may include receiving a message indicating a set of multiple contention-based resource sets dedicated for scheduling requests, each contention-based resource set of the set of multiple contention-based resource sets being associated with one or more respective conditions and transmitting a scheduling request to request uplink resources for the UE using a resource of a contention-based resource set of the set of multiple contention-based resource sets based on satisfaction of the one or more respective conditions for the contention-based resource set and on a successful contention-based procedure for the contention-based resource set.

An apparatus for wireless communication at a UE is described. The apparatus may include a processor, memory coupled with the processor, and instructions stored in the memory. The instructions may be executable by the processor to cause the apparatus to receive a message indicating a set of multiple contention-based resource sets dedicated for scheduling requests, each contention-based resource set of the set of multiple contention-based resource sets being associated with one or more respective conditions and transmit a scheduling request to request uplink resources for the UE using a resource of a contention-based resource set of the set of multiple contention-based resource sets based on satisfaction of the one or more respective conditions for the contention-based resource set and on a successful contention-based procedure for the contention-based resource set.

Another apparatus for wireless communication at a UE is described. The apparatus may include means for receiving a message indicating a set of multiple contention-based resource sets dedicated for scheduling requests, each contention-based resource set of the set of multiple contention-based resource sets being associated with one or more respective conditions and means for transmitting a scheduling request to request uplink resources for the UE using a resource of a contention-based resource set of the set of multiple contention-based resource sets based on satisfaction of the one or more respective conditions for the contention-based resource set and on a successful contention-based procedure for the contention-based resource set.

A non-transitory computer-readable medium storing code for wireless communication at a UE is described. The code may include instructions executable by a processor to receive a message indicating a set of multiple contention-based resource sets dedicated for scheduling requests, each contention-based resource set of the set of multiple contention-based resource sets being associated with one or more respective conditions and transmit a scheduling request to request uplink resources for the UE using a resource of a contention-based resource set of the set of multiple contention-based resource sets based on satisfaction of the one or more respective conditions for the contention-based resource set and on a successful contention-based procedure for the contention-based resource set.

In some examples of the method, apparatuses, and non-transitory computer-readable medium described herein, transmitting the scheduling request may include operations, features, means, or instructions for transmitting, using the resource of the contention-based resource set, the scheduling request based on a remaining packet delay budget of an uplink message associated with the scheduling request being greater than a packet delay threshold, where the satisfaction of the one or more respective conditions of the contention-based resource set includes the remaining packet delay budget being greater than the packet delay threshold.

In some examples of the method, apparatuses, and non-transitory computer-readable medium described herein, transmitting the scheduling request may include operations, features, means, or instructions for transmitting, using the resource of the contention-based resource set, the scheduling request based on a remaining packet delay budget of an uplink message associated with the scheduling request being greater than a first packet delay threshold and being less than a second packet delay threshold, where the satisfaction of the one or more respective conditions of the contention-based resource set includes the remaining packet delay budget being greater than the first packet delay threshold and less than the second packet delay threshold.

In some examples of the method, apparatuses, and non-transitory computer-readable medium described herein, transmitting the scheduling request may include operations, features, means, or instructions for transmitting, using the resource of the contention-based resource set, the scheduling request based on a buffer size of the UE being greater than a buffer size threshold, where the satisfaction of the one or more respective conditions of the contention-based resource set includes the buffer size of the UE being greater than the buffer size threshold.

In some examples of the method, apparatuses, and non-transitory computer-readable medium described herein, transmitting the scheduling request may include operations, features, means, or instructions for transmitting, using the resource of the contention-based resource set, the scheduling request based on a buffer size of the UE being less than a buffer size threshold, where the satisfaction of the one or more respective conditions of the contention-based resource set includes the buffer size of the UE being less than the buffer size threshold.

In some examples of the method, apparatuses, and non-transitory computer-readable medium described herein, transmitting the scheduling request may include operations, features, means, or instructions for transmitting, using the resource of the contention-based resource set, the scheduling request based on a buffer size of the UE being greater than a first buffer size threshold and being less than a second buffer size threshold, where the satisfaction of the one or more respective conditions of the contention-based resource set includes the buffer size of the UE being greater than the first buffer size threshold and less than the second buffer size threshold.

Some examples of the method, apparatuses, and non-transitory computer-readable medium described herein may further include operations, features, means, or instructions for receiving an indication of a probability function associated with the set of multiple contention-based resource sets, the probability function being associated with a packet delay time of the UE and computing a probability using the probability function and the packet delay time of the UE, where transmitting the scheduling request using the resource of the contention-based resource set may be based on the probability satisfying a probability threshold of the contention-based resource set.

Some examples of the method, apparatuses, and non-transitory computer-readable medium described herein may further include operations, features, means, or instructions for receiving an indication of the one or more respective conditions associated with each contention-based resource set of the set of multiple contention-based resource sets.

Some examples of the method, apparatuses, and non-transitory computer-readable medium described herein may further include operations, features, means, or instructions for receiving a radio resource control (RRC) message indicating the set of multiple contention-based resource sets and receiving a layer 1 (L1) or layer 2 (L2) signal indicating activation of the set of multiple contention-based resource sets.

In some examples of the method, apparatuses, and non-transitory computer-readable medium described herein, transmitting the scheduling request may include operations, features, means, or instructions for transmitting, using the resource of the contention-based resource set, the scheduling request based on a random selection of the resource from the contention-based resource set, where the successful contention-based procedure includes the random selection of the resource from the contention-based resource set.

In some examples of the method, apparatuses, and non-transitory computer-readable medium described herein, transmitting the scheduling request may include operations, features, means, or instructions for transmitting the scheduling request using a cyclic shift that may be mapped to a radio network temporary identifier (RNTI) of the UE.

In some examples of the method, apparatuses, and non-transitory computer-readable medium described herein, the set of multiple contention-based resource sets may be periodic.

In some examples of the method, apparatuses, and non-transitory computer-readable medium described herein, each contention-based resource set of the set of multiple contention-based resource sets may be associated with a respective logical channel.

In some examples of the method, apparatuses, and non-transitory computer-readable medium described herein, the uplink resources may be for an uplink message that includes a virtual reality (XR) uplink message or a ultra-reliable low latency communication (URLLC) uplink message.

A method for wireless communication at a network entity is described. The method may include transmitting a message indicating a set of multiple contention-based resource sets dedicated for scheduling requests for one or more UEs, each contention-based resource set of the set of multiple contention-based resource sets being associated with one or more respective conditions and receiving, via a resource of a contention-based resource set of the set of multiple contention-based resource sets, a scheduling request that requests uplink resources from a first UE, the contention-based resource set being based on satisfaction of the one or more respective conditions for the contention-based resource set at the first UE and on a successful contention-based procedure for the contention-based resource set at the first UE.

An apparatus for wireless communication at a network entity is described. The apparatus may include a processor, memory coupled with the processor, and instructions stored in the memory. The instructions may be executable by the processor to cause the apparatus to transmit a message indicating a set of multiple contention-based resource sets dedicated for scheduling requests for one or UEs, each contention-based resource set of the set of multiple contention-based resource sets being associated with one or more respective conditions and receive, via a resource of a contention-based resource set of the set of multiple contention-based resource sets, a scheduling request that requests uplink resources from a first UE, the contention-based resource set being based on satisfaction of the one or more respective conditions for the contention-based resource set at the first UE and on a successful contention-based procedure for the contention-based resource set at the first UE.

Another apparatus for wireless communication at a network entity is described. The apparatus may include means for transmitting a message indicating a set of multiple contention-based resource sets dedicated for scheduling requests for one or more UEs, each contention-based resource set of the set of multiple contention-based resource sets being associated with one or more respective conditions and means for receiving, via a resource of a contention-based resource set of the set of multiple contention-based resource sets, a scheduling request that requests uplink resources from a first UE, the contention-based resource set being based on satisfaction of the one or more respective conditions for the contention-based resource set at the first UE and on a successful contention-based procedure for the contention-based resource set at the first UE.

A non-transitory computer-readable medium storing code for wireless communication at a network entity is described. The code may include instructions executable by a processor to transmit a message indicating a set of multiple contention-based resource sets dedicated for scheduling requests for one or more UEs, each contention-based resource set of the set of multiple contention-based resource sets being associated with one or more respective conditions and receive, via a resource of a contention-based resource set of the set of multiple contention-based resource sets, a scheduling request that requests uplink resources from a first UE, the contention-based resource set being based on satisfaction of the one or more respective conditions for the contention-based resource set at the first UE and on a successful contention-based procedure for the contention-based resource set at the first UE.

In some examples of the method, apparatuses, and non-transitory computer-readable medium described herein, receiving the scheduling request may include operations, features, means, or instructions for receiving, via the resource of the contention-based resource set, the scheduling request based on a remaining packet delay budget of an uplink message associated with the scheduling request being greater than a packet delay threshold, where the satisfaction of the one or more respective conditions of the contention-based resource set includes the remaining packet delay budget of the first UE being greater than the packet delay threshold.

In some examples of the method, apparatuses, and non-transitory computer-readable medium described herein, receiving the scheduling request may include operations, features, means, or instructions for receiving, via the resource of the contention-based resource set, the scheduling request based on a remaining packet delay budget of an uplink message associated with the scheduling request being greater than a first packet delay threshold and being less than a second packet delay threshold, where the satisfaction of the one or more respective conditions of the contention-based resource set includes the remaining packet delay budget of the first UE being greater than the first packet delay threshold and less than the second packet delay threshold.

In some examples of the method, apparatuses, and non-transitory computer-readable medium described herein, receiving the scheduling request may include operations, features, means, or instructions for receiving, via the resource of the contention-based resource set, the scheduling request based on a buffer size of the first UE being greater than a buffer size threshold, where the satisfaction of the one or more respective conditions of the contention-based resource set includes the buffer size of the first UE being greater than the buffer size threshold.

In some examples of the method, apparatuses, and non-transitory computer-readable medium described herein, receiving the scheduling request may include operations, features, means, or instructions for receiving, via the resource of the contention-based resource set, the scheduling request based on a buffer size of the first UE being less than a buffer size threshold, where the satisfaction of the one or more respective conditions of the contention-based resource set includes the buffer size of the first UE being less than the buffer size threshold.

In some examples of the method, apparatuses, and non-transitory computer-readable medium described herein, receiving the scheduling request may include operations, features, means, or instructions for receiving, using the resource of the contention-based resource set, the scheduling request based on a buffer size of the first UE being greater than a first buffer size threshold and being less than a second buffer size threshold, where the satisfaction of the one or more respective conditions of the contention-based resource set includes the buffer size of the first UE being greater than the first buffer size threshold and less than the second buffer size threshold.

Some examples of the method, apparatuses, and non-transitory computer-readable medium described herein may further include operations, features, means, or instructions for transmitting an indication of a probability function associated with the set of multiple contention-based resource sets, the probability function being based on a packet delay time of each UE of the one or more UEs, where receiving the scheduling request via the resource of the contention-based resource set may be based on a computed probability of the first UE satisfying a probability threshold of the contention-based resource set.

Some examples of the method, apparatuses, and non-transitory computer-readable medium described herein may further include operations, features, means, or instructions for transmitting an indication of the one or more respective conditions associated with each contention-based resource set of the set of multiple contention-based resource sets.

Some examples of the method, apparatuses, and non-transitory computer-readable medium described herein may further include operations, features, means, or instructions for transmitting a RRC message indicating the set of multiple contention-based resource sets and transmitting a L1 or L2 signal indicating activation of the set of multiple contention-based resource sets.

In some examples of the method, apparatuses, and non-transitory computer-readable medium described herein, receiving the scheduling request may include operations, features, means, or instructions for receiving, via the resource of the contention-based resource set, the scheduling request based on a random selection of the resource from the contention-based resource set by the first UE, where the successful contention-based procedure includes the random selection of the resource from the contention-based resource set by the first UE.

In some examples of the method, apparatuses, and non-transitory computer-readable medium described herein, receiving the scheduling request may include operations, features, means, or instructions for receiving the scheduling request that may be associated with a cyclic shift that may be mapped to an RNTI of the first UE.

In some examples of the method, apparatuses, and non-transitory computer-readable medium described herein, the set of multiple contention-based resource sets may be periodic.

In some examples of the method, apparatuses, and non-transitory computer-readable medium described herein, each contention-based resource set of the set of multiple contention-based resource sets may be associated with a respective logical channel.

In some examples of the method, apparatuses, and non-transitory computer-readable medium described herein, the uplink resources may be for an uplink message that includes an XR uplink message or a URLLC uplink message.

### BRIEF DESCRIPTION OF THE DRAWINGS

FIG. 1 illustrates an example of a wireless communications system that supports contention-based scheduling request resources in accordance with one or more aspects of the present disclosure.

FIG. 2 illustrates an example of a network architecture that supports contention-based scheduling request resources in accordance with one or more aspects of the present disclosure.

FIG. 3 illustrates an example of a wireless communications system that supports contention-based scheduling request resources in accordance with one or more aspects of the present disclosure.

FIG. 4 illustrates an example of a timing diagram that supports contention-based scheduling request resources in accordance with one or more aspects of the present disclosure.

FIG. 5 illustrates an example of a process flow that supports contention-based scheduling request resources in accordance with one or more aspects of the present disclosure.

FIGS. 6 and 7 illustrate block diagrams of devices that support contention-based scheduling request resources in accordance with one or more aspects of the present disclosure.

FIG. 8 illustrates a block diagram of a communications manager that supports contention-based scheduling request resources in accordance with one or more aspects of the present disclosure.

FIG. 9 illustrates a diagram of a system including a device that supports contention-based scheduling request resources in accordance with one or more aspects of the present disclosure.

FIGS. 10 and 11 illustrate block diagrams of devices that support contention-based scheduling request resources in accordance with one or more aspects of the present disclosure.

FIG. 12 illustrates a block diagram of a communications manager that supports contention-based scheduling request resources in accordance with one or more aspects of the present disclosure.

FIG. 13 illustrates a diagram of a system including a device that supports contention-based scheduling request resources in accordance with one or more aspects of the present disclosure.

FIGS. 14 through 17 illustrate flowcharts showing methods that support contention-based scheduling request resources in accordance with one or more aspects of the present disclosure.

### DETAILED DESCRIPTION

In some wireless communications systems, a user equipment (UE) may transmit, to a network entity, one or more scheduling requests to request uplink resources for the UE. To transmit a scheduling request, the network entity may allocate periodic resources for the UE, such that, when the UE has an uplink message to transmit, the UE may use the periodic resources to transmit a scheduling request to the network entity. In response to receiving the scheduling request, the network entity may transmit an uplink grant to schedule uplink resources for the UE, which the UE may use to transmit the uplink message. In some cases, however, if the periodicity of the resources allocated for scheduling requests is above a threshold periodicity (e.g., relatively longer compared to other periods of scheduling request resources), the UE may experience increased delays in transmitting the scheduling requests, further delaying the grant of uplink resources and transmission of the uplink message. In such cases, the UE may be unable to meet the latency constraints of the uplink message (e.g., low latency communication such as virtual reality (XR) packets or ultra-reliable low latency communication (URLLC) packets) due to the increased delay. Alternatively, if a periodicity of the resources allocated for scheduling requests is below a threshold (e.g., relatively shorter compared to other periods for scheduling request resources), the UE may transmit scheduling requests at a relatively higher frequency, which may result in higher resource usage and overhead, thereby reducing the uplink channel capacity (e.g., due to scheduling requests transmitted by one or more UEs).

The techniques described herein may enable a network entity to configure one or more UEs in a wireless communications system with contention-based resources for scheduling requests. For example, the network entity may transmit multiple contention-based resource sets dedicated for scheduling requests to one or more UEs, where each contention-based resource set is associated with one or more respective conditions. Thus, when a UE has an uplink message to transmit, the UE may select a contention-based resource set of the multiple contention-based resource sets based on satisfying the one or more conditions associated with the contention-based resource set. In some examples, the one or more respective conditions of the contention-based resource set may be associated with a packet delay threshold. In such examples, the UE may use the resources of the contention-based resource set for scheduling requests based on a remaining packet delay budget of the uplink message at the UE satisfying the packet delay threshold (e.g., a condition) of the contention-based resource set. In some other examples, the one or more respective conditions of the contention-based resource set may be associated with a buffer size threshold. In such examples, the UE may use the resources of the contention-based resource set based on a buffer size of the UE satisfying the buffer size threshold (e.g., a condition) of the contention-based resource set. After selecting the contention-based resource set, the UE may select (e.g., randomly) a resource of the contention-based resource set and transmit the scheduling request to the network entity. In this way, the network entity may allocate contention-based resources for one or more UEs to use for scheduling request transmissions, thereby enabling each UE to access resources in an efficient manner.

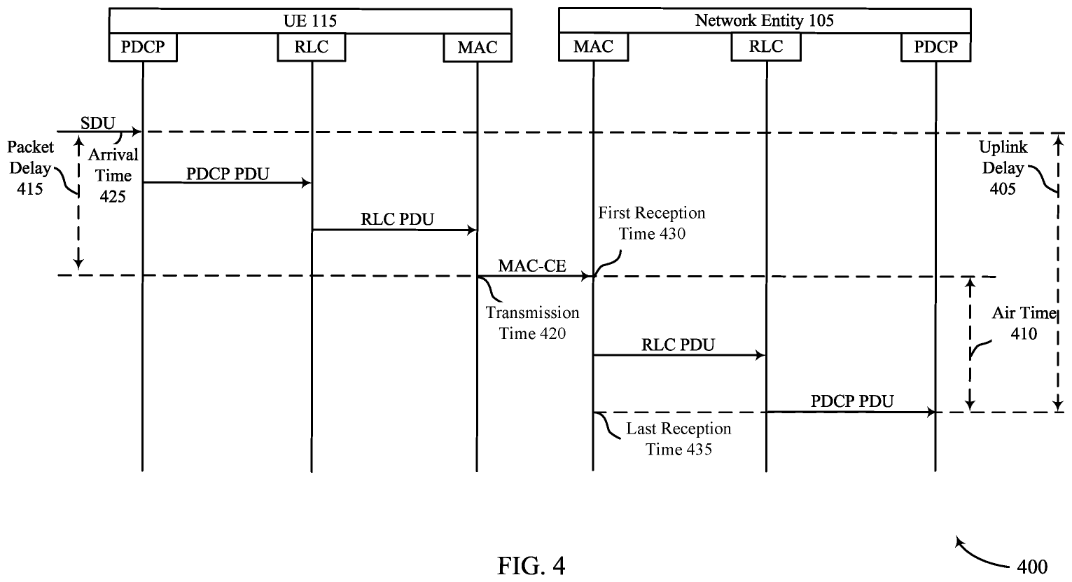

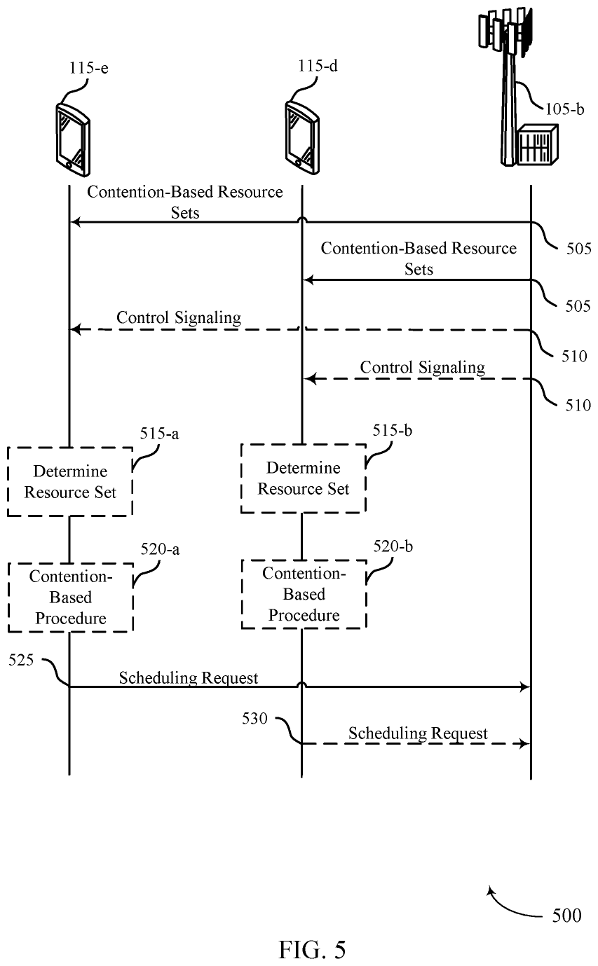

Aspects of the disclosure are initially described in the context of wireless communications systems. Aspects of the disclosure are further illustrated by to a timing diagram and a process flow as described herein with reference to FIGS. 4 and 5. Aspects of the disclosure are further illustrated by and described with reference to apparatus diagrams, system diagrams, and flowcharts that relate to contention-based scheduling request resources.

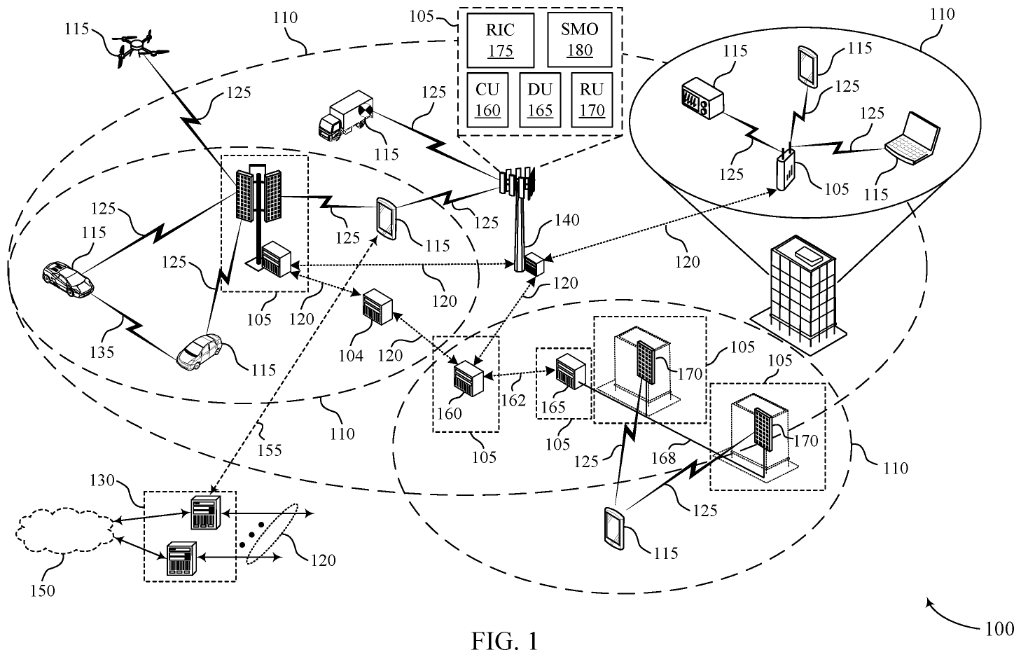

FIG. 1 illustrates an example of a wireless communications system 100 that supports contention-based scheduling request resources in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support contention-based scheduling request resources as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may for example, refer to a sampling period of Tₛ=1/(Δfₘₐₓ·N_{f}) seconds, for which Δfₘₐₓ may represent a supported subcarrier spacing, and may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples of the wireless communications system 100, the UE 115 may transmit a scheduling request to request uplink resources for an uplink message via a first physical uplink control channel (PUCCH) format (e.g., PUCCH format 1).

In some examples of the wireless communications system 100, the UE 115 and the network entity 105 may perform XR, mixed reality (MR), virtual reality (VR), or other low latency types, communications (e.g., via one or more XR flows). Such XR communications may have frequent uplink packets and strict delay budgets (e.g., to enhance the experience of XR at the UE 115). In such cases, the UE 115 may transmit multiple scheduling requests to the network entity in order to transmit the XR uplink packets. However, delays from scheduling request transmissions may be relatively high in cases when the periodicity of the scheduling request transmissions is too large. For example, if the period at which the UE 115 can use the scheduling request resources is relatively long (e.g., above a threshold), then the UE 115 may have to wait to transmit scheduling requests, thereby delaying the XR uplink transmissions (e.g., and risk not meeting the XR packets tight delay budgets). Alternatively, relatively shorter (e.g., below a threshold that may be different that the threshold for longer periods) scheduling request periodicity may reduce the uplink channel capacity due to an increased amount of uplink channel resource reservation by UEs transmitting scheduling requests, receiving grants for uplink resources, or both, among other factors. For example, if the period at which the UE 115 can use the scheduling request resources is relatively small, the UE 115 may continuously transmit scheduling requests (e.g., due to the frequency XR uplink packets), thereby reducing the uplink channel capacity for other UEs 115 in the network.

The techniques described herein propose for a contention-based scheduling request design in order to allow the reuse of scheduling request resources across multiple UEs 115. As such, the UEs 115 may perform a random uplink channel resource reservation in order to transmit the scheduling requests. To avoid collisions and false detections at the network entity 105 (e.g., due to multiple UEs 115 using the same contention-based resource sets), the network entity 105 may configure one or more conditions for each respective contention-based resource set, such that a UE 115 of the multiple UEs 115 may use the resources of a contention-based resource set, thereby randomizing the UEs 115.

For example, the network entity 105 may transmit multiple contention-based resource sets dedicated for scheduling requests to the multiple UEs 115, where each contention-based resource set is associated with one or more respective conditions. Thus, when a UE 115 has an uplink message to transmit, the UE 115 may select a contention-based resource set of the multiple contention-based resource sets based on satisfying the one or more conditions associated with the contention-based resource set. In some examples, the one or more respective conditions of the contention-based resource set may be associated with a packet delay threshold. In such examples, the UE 115 may use the resources of the contention-based resource set for scheduling requests based on a remaining packet delay budget of an uplink message at the UE 115 satisfying a packet delay threshold of the contention-based resource set. In some other examples, the one or more respective conditions of the contention-based resource set may be associated with a buffer size threshold. In such examples, the UE 115 may use the resources of the contention-based resource set based on a buffer size of the UE 115 satisfying the buffer size threshold of the contention-based resource set. After selecting the contention-based resource set, the UE 115 may randomly select a resource of the contention-based resource set and transmit the scheduling request to the network entity 105. In this way, the network entity 105 may allocate contention-based resources for one or more UEs 115 to use to transmit scheduling requests, thereby enabling each UE 115 to access resources in a timely and efficient manner.

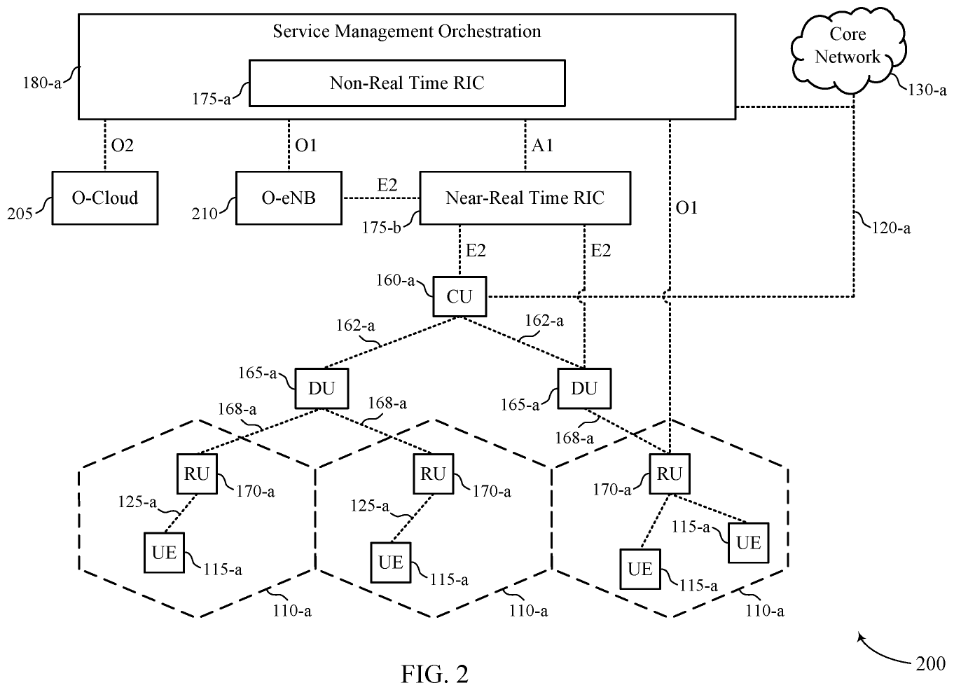

FIG. 2 illustrates an example of a network architecture 200 (e.g., a disaggregated base station architecture, a disaggregated RAN architecture) that supports contention-based scheduling request resources in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

The techniques described herein may enable a group of UEs 115-a (e.g., one or more UEs 115-a in the same service area 110) to use multiple contention-based resource sets to transmit scheduling requests to a network entity 105. For example, one or more UEs 115-a may receive, from a CU 160-a, RRC signaling, indicating multiple contention-based resource sets, where each contention-based resource set is associated with a one or more respective conditions. Further, the one or more UEs 115-a may receive, from a DU 168-a, L1 or L2 signaling activating contention-based resource sets (e.g., enabling the one or more UEs 115-a to use resources of the contention-based resource sets to transmit scheduling requests).

In some examples, a UE 115-a of the one or more UEs 115-a may use a resource of a contention-based resource set of the multiple contention-based resource sets based on satisfaction of one or more respective conditions associated with the contention-based resource set. In one example, to use the resources of the contention-based resource set, the UE 115-a may have a remaining packet delay budget (e.g., packet delay) that satisfies a packet delay threshold of the contention-based resource set. In another example, to use the contention-based resource set, the UE 115-a may have a buffer size (e.g., amount of data to be transmitted at the UE 115-a) that satisfies a buffer size threshold associated with the contention-based resource set. Based on selecting the contention-based resource set, the UE 115-a may perform a contention-based procedure to randomly select a resource out of the contention-based resource set.

Based on successful completion of the contention-based procedure, the UE 115-a may transmit, using the resource of the contention-based resource set, the scheduling request to the network entity 105.

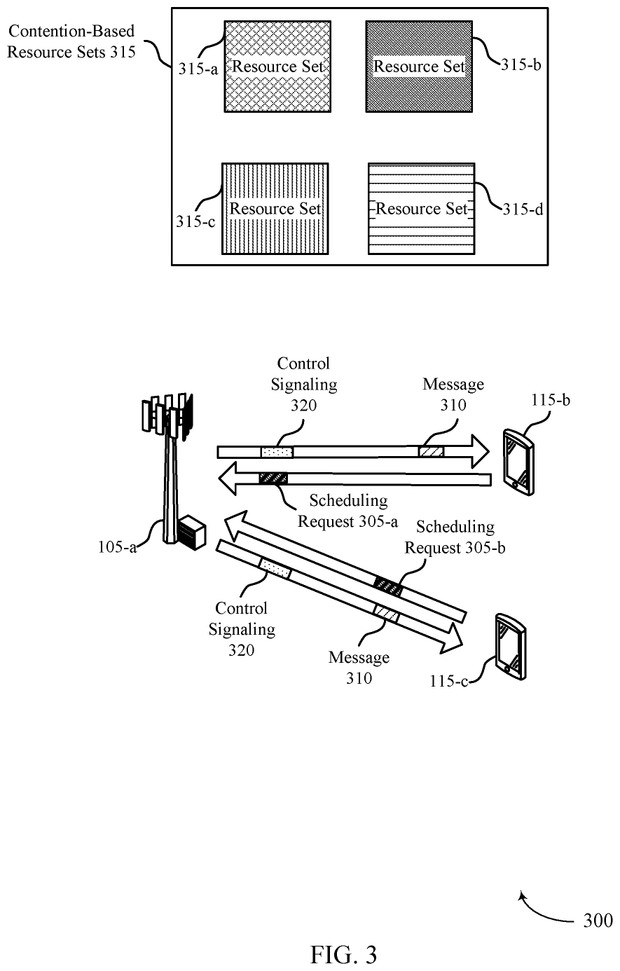

FIG. 3 illustrates an example of a wireless communications system 300 that supports contention-based scheduling request resources in accordance with one or more aspects of the present disclosure. The wireless communications system 300 may implement or be implemented by aspects of wireless communications system 100 with reference to FIGS. 1 and 2. For example, the wireless communications system 300 may include a network entity 105-a, a UE 115-b, and a UE 115-c, which may be examples of corresponding network entities and UEs described herein.

In some cases of the wireless communications system 300, the UEs 115 may communicate one or more uplink messages to the network entity 105-a. In order to transmit the uplink messages, the UEs 115 may transmit scheduling requests 305 requesting resources for the uplink messages. In response to the scheduling requests 305, the network entity 105-a may allocate resources for the UEs 115 to use for transmission of the uplink messages. In some cases, the UEs 115 may use periodic resources to transmit the scheduling requests 305. For example, the network entity 105-a may indicate a first resource with a first periodicity to the UE 115-b, such that the UE 115-b may use the first resource, in accordance with the first periodicity, for transmission of a scheduling request 305-a. Likewise, the network entity 105-a may allocate a second resource with a second periodicity to the UE 115-c, such that the UE 115-c may use the second resource, in accordance with the second periodicity, for transmission of the scheduling request 305-b.

Setting or configuring (e.g., by the network entity 105-a or other network node) the periodicity (e.g., optimal periodicity) for each scheduling request resource may depend on the traffic at the UE 115-b and the UE 115-c. However, such information may not be available to the network entity 105-a at the time of resource allocation. As such, if the network entity 105-a indicates a relatively large scheduling request periodicity, the UEs 115 may not be able to transmit uplink messages in a timely manner (e.g., due to the large delays created by the large scheduling request periodicity). Alternatively, if the network entity 105-b indicates a relatively small periodicity, the UEs 115 may transmit scheduling requests 305 more frequently, thereby reducing (e.g., through use of additional resources) the channel capacity of the uplink channel.

In some implementations of the wireless communications system 300, the network entity 105-a may configure contention-based resource sets 315 (e.g., uplink channel resources) that may be collectively used and selected (e.g., randomly or via satisfaction of one or more conditions) by the UEs 115. For example, the network entity 105-a may transmit a message 310 to the UE 115-b and the UE 115-c, indicating several contention-based resource sets 315 (e.g., such as resource set 315-a, resource set 315-b, resource set 315-c, and resource set 315-d). Such contention-based resource sets 315 may be shared by the UE 115-b and the UE 115-c for the transmission of scheduling requests 305. Thus, when the UEs 115 transmit scheduling requests 305, the UEs 115 may select one contention-based resource set 315 of the contention-based resource sets 315 based on satisfying one or more respective conditions associated with the contention-based resource set 315. Based on selecting the contention-based resource set 315, the UEs 115 may randomly select a resource of the contention-based resource set 315 to use for the transmission of the scheduling requests 305.

Further, the network entity 105-a may configure the UEs 115 to reuse the contention-based resource sets 315 (e.g., scheduling request resources) at random based on the one or more respective conditions of each resource set being satisfied. The conditions associated with each contention-based resource set 315 may be based on a packet delay of an uplink message at the UEs 115 or a buffer size of the UEs 115. Additionally, each contention-based resource set 315 may be configured for the same logical channel (e.g., logical control channels or logical traffic channels), where each contention-based resource set 315 may correspond to a different incurred packet delay latency. As such, based on receiving the scheduling requests 305 from specific contention-based resource sets 315, the network entity 105-b may have indication to which uplink messages to prioritize (e.g., prioritize scheduling). That is, the network entity 105-a may infer from the resources used to receive the scheduling requests 305 which UEs 115 may have more uplink data to be transmitted (e.g., due to the UEs 115 using the resource of a contention-based resource set 315 based on satisfying the associated condition).

In some examples, the network entity 105-a may define the contention-based resource sets 315 (e.g., regions) based on the size of the buffer status reports at the UEs 115, logical channel groups of the uplink messages at the UEs 115, the buffer state associated with specific logical channel groups, or a remaining packet delay budget (e.g., such as a packet delay time) associated with an uplink message at the UEs 115 in order for each UE 115 to determine the probability of utilizing a resource of the contention-bases resource sets 315 (e.g., a scheduling request occasion). Thus, the UEs 115 that have a relatively large quantity of data in the buffer or have a relatively smaller remaining packet delay budget (e.g., having large packet delays) may have a higher probability of using the contention-based resource sets 315 and may subsequently use the resources of the contention-based resource sets 315 more quickly.

In some examples, the network entity 105-a may configure one or more conditions of the resource set 315-a to be based on a buffer status threshold and be specific to a first logical channel. As such, the UEs 115 may use the resources of the resource set 315-a in the case that the UEs 115 have a buffer status report size that is greater than the buffer status report threshold and the uplink message is intended for the specific logical channel (e.g., if buffer status report of the UEs 115>buffer status threshold and the uplink message is for X logical channel, then the UEs 115 may use the PUCCH resources of the resource set 315-a). Likewise, the network entity 105-a may configure the one or more conditions of the resource set 315-b to be based on the buffer status threshold and be specific to a second logical channel. As such, the UEs 115 may use the resources of the resource set 315-b in the case that the size of the buffer status report at the UEs 115 is less than the buffer status threshold and the uplink message of the UEs 115 is intended for the second logical channel (e.g., if buffer status report of the UEs 115<buffer status threshold and the uplink message is for Y logical channel, then the UEs 115 may use the PUCCH resources of the resource set 315-b).

Further, the network entity 105-a may configure the one or more conditions associated with the resource set 315-c to be based on two buffer status report thresholds. As such, the UEs 115 may use the resources of the resource set 315-c in the case that the size of the buffer status report at the UEs 115 is less than a first buffer status threshold and greater than a second buffer status threshold (e.g., if threshold 2<buffer status report of the UE<threshold 1, then the UEs 115 may use the PUCCH resources of the resource set 315-c). Similarly, the network entity 105-a may indicate that one or more resource sets 315 of the multiple contention-based resource sets 315 (e.g., regions of PUCCH resources) may be used if a delay experienced at each UE 115 is compared to, and satisfies, a threshold (e.g., a packet delay threshold).

That is, the network entity 105-a may configure a combination of conditions for the resource set 315-a (e.g., a combination of resource sets 315 with either packet delay threshold conditions or buffer status threshold conditions). For example, the network entity 105-a may configure the one or more conditions of the resource set 315-a to be based on a packet delay threshold, such that if a remaining packet delay budget (e.g., a packet delay further described herein with reference to FIG. 3) of the UEs 115 is greater than the packet delay threshold of the resource set 315-a, then the UEs 115 may use the PUCCH resources of the resource set 315-a (e.g., remaining packet delay budget>packet delay threshold). Likewise, the network entity 105-a may configure the one or more conditions associated with the resource set 315-b to be based on a first packet delay threshold and a second packet delay threshold, such that if the remaining packet delay budget of the UEs 115 is greater than the first packet delay threshold and less than the second packet delay threshold, the UEs 115 may use the PUCCH resources of the resource set 315-b (e.g., threshold 1<remaining packet delay budget<threshold 2).

In such examples, the network entity 105-a may configure the one or more conditions of the resource set 315-c to be based on the buffer status threshold, such that if the size of the buffer status report of the UEs 115 is less than the buffer status threshold, the UEs 115 may use the PUCCH resources of resource set 315-c (e.g., buffer status report<threshold). Likewise, the network entity 105-a may configure the one or more conditions associated with the resource set 315-d to be based on the buffer status threshold, such that if the buffer status report of the UEs 115 is greater than the buffer status threshold, then the UEs 115 may use the PUCCH resources of the resource set 315-d (e.g., buffer status report >threshold). In this way, the network entity 105-a may configure a combination of conditions for the respective contention-based resource sets 315 (e.g., respective PUCCH regions or resources). Further, by configuring region-based conditions (e.g., resource set based conditions), the network entity 105-a may infer (e.g., implicitly learn) about the uplink delays and buffer status report of each UE 115 prior to each UE 115 transmitting respective buffer status reports.

In some examples, the network entity 105-a may configure the one or more conditions associated with each contention-based resource set 315 based on a probability function. For example, to avoid collision and false detection at the network entity 105-a, the network entity 105-a may configure the UEs 115 with probability function, where the probability function is a function of the remaining packet delay budget or a function of T_wait, which may be the time that a packet has been buffered at a MAC layer of the UE. In some cases, the time T_wait may also include the time from packet arrival at a PDCP layer of the UE to packet arrival at the MAC layer (e.g., received at the MAC layer from the PDCP layer via the RLC layer) in addition to the time that a packet has been buffered at the MAC layer of the UE, T_wait may be further described herein with reference to FIG. 3.

For example, the UEs 115 may be configured with or determine a probability based on the probability function and the remaining packet delay budget, T_wait, or both. In some examples, the UEs 115 may compare the probability to respective probability thresholds associated with each resource set 315. The UEs 115 may use the PUCCH resources a resource set 315 if the computed probability satisfies the respective probability thresholds.

In another example, if the remaining packet delay budget or T_wait for an uplink message at the UEs 115 is greater than a packet delay threshold (e.g., T_wait>T1) then the computed probability of the UE 115 may be equal to 1, which indicates that the UE 115 is 100% probability that the UE 115 can select any resource set provided that the respective conditions for that resource set are satisfied. If the remaining packet delay budget or T_wait for an uplink message at the UE 115 is less than a packet delay threshold (e.g., T_wait<T1) then the computed probability of the UE 115 may be equal to 0, which indicates that the UE 115 is 0% probability that the UE 115 can select any resource set provided that the respective conditions for that resource set are satisfied. In this case, because T_wait is below a threshold, the UE 115 may not select a resource set, at least until T_wait exceeds the threshold and the probably for the UE 115 changes. Further, if the remaining packet delay budget or T_wait for an uplink message at the UEs 115 is greater than a second packet delay threshold (e.g., T_wait<T2) then the computed probability of the UEs 115 may be between 0 and 1 (e.g., 0.5). If the probability is 0.5, the UE 115 may have a 50% probability that the UE 115 can select a resource set provided that the respective conditions for that resource set are satisfied. In such examples, UEs 115 with T_wait exceeding a threshold of T1 are given higher priority (based on the probability function) to use or select resource sets compared to UEs 115 with T_wait that fall below a threshold of T2 or T1. Different T1 and T2 thresholds may be configured or associated with different resource sets and in some cases, the T1 and T2 thresholds may be part of the conditions for a given resource set. This may provide flexibility for different resource sets and different UEs having different values of T_wait or remaining packet delay budget such that not all UEs are granted unrestricted access to selection of any resource set provided that the respective conditions are met. Such techniques may reduce collisions and prioritize UEs having packets with higher T_wait times, which may help meet latency targets for some packets.

In some examples, network entity 105-a may configure the contention-based resource sets 315 via control signaling 320. For example, the network entity 105-a may transmit an indication of each resource set 315 via higher layer signaling (e.g., such as RRC signaling). In such examples, the network entity 105-a may indicate, via control signaling 320, the one or more conditions associated with each contention-based resource set 315. Further, the network entity 105-a may activate the use of the contention-based resource sets 315 or configure the T1, T2 thresholds for the contention-based resource sets 315 via L1 or L2 signaling. That is, the network entity 105-a may transmit RRC signaling to the UEs 115 indicating the respective resource sets 315 and the conditions associated with each resource set 315. The network entity 105-a may transmit L1 or L2 signaling activating the use of, or the T1, T2 thresholds for, the contention-based resource sets 315.

After selecting the contention-based resource set 315, the UEs 115 may perform a contention-based procedure (e.g., clear channel access (CCA), listen before talk (LBT) to select a resource from the selected contention-based resource set 315. For example, the UE 115-b may satisfy the one or more conditions associated with the resource set 315-a. As such, the UE 115-b may randomly select a resource, from the resource set 315-a, that has a successful contention-based procedure, in order to transmit the scheduling request 305-a.

In some examples, the UE 115-b may transmit the scheduling request 305-a via a first PUCCH format (e.g., PUCCH format 1). In some other examples, one or more PUCCH formats may be utilized by multiple UEs 115 (e.g., the UEs 115). In the first PUCCH format, the UEs 115 may include cyclic shifts to distinguish between HARQ-ACK bits and data bits. In order for the network entity 105-a to identify multiple scheduling request transmission from multiple UEs 115 via the resource or resource set 315, the UEs 115 may transmit the scheduling requests according to different cyclic shifts, such that the cyclic shift of the scheduling request 305-a is different from the cyclic shift for the scheduling request 305-b. In such examples, the cyclic shifts of each transmission may be mapped to a cell radio network temporary identifier (C-RNTI) of the UEs 115. In this way, the network entity 105-a may receive each scheduling request, identify which UE 115 transmitted the scheduling request, and provide each UE 115 with a corresponding uplink grant encoded using the C-RNTI.

FIG. 4 illustrates an example of a timing diagram 400 that supports contention-based scheduling request resources in accordance with one or more aspects of the present disclosure. Aspects of the timing diagram 400 may implement, or be implemented by, aspects of the wireless communications system 100, the network architecture 200, and the wireless communications system 300. For example, the timing diagram be associated with a UE 115 and a network entity 105, which may be examples of corresponding devices described herein with reference to FIGS. 1 through 3.

The timing diagram 400 may illustrate the transmission and reception of an uplink packet between the UE 115 and the network entity 105. To facilitate the such communications, the UE 115 and the network entity 105 may use one or more protocol layers, such as a PDCP layer, a RLC layer, and a MAC layer. For example, the PDCP layer of the UE 115 may receive a service data unit (SDU) (e.g., uplink data to be transmitted), where the PDCP layer of the UE 115 may generate a PDCP packet data unit (PDU) based on the received SDU (e.g., add one or more additional headers to the SDU packet). The PDCP layer may transfer the PDCP PDU to the RLC layer, where RLC layer may generate an RLC PDU. The MAC layer may receive the RLC PDU and generate a MAC control element (MAC-CE). Based on generating the MAC-CE, the UE 115 may transmit the MAC-CE to network entity 105, where the network entity 105 may decode the MAC-CE at the MAC layer to obtain the RLC PDU. The RLC layer of the network entity 105 may receive and decode the RLC PDU to obtain the PDCP PDU. The PDCP layer of the network entity 105 may receive and decode the PDCP PDU to obtain the SDU (e.g., uplink data).

In such communications, the network entity 105 and the UE 115 may experience an uplink delay 405. The uplink delay 405 (e.g., at the air interface of the network entity 105) may be broken into the airtime 410 (e.g., T_Air) and the packet delay 415 (e.g., T_wait). That is, the uplink delay 405 may be the airtime 410 experienced at the network entity 105 plus the packet delay 415 experienced at the UE 115 (e.g., UplinkDelay=T_Air+T_wait).

The packet delay 415 (e.g., a remaining packet delay budget) may represent a waiting time between the arrival time 425 of the SDU (e.g., T_Arrival) to the transmission time 420 of the MAC-CE (e.g., T_First) containing the packets of the SDU. For example, when an SDU arrives in the PDCP queue, the UE 115 may store the arrival time 425 in memory. As such, when the UE 115 transmits the first MAC PDU containing data from the received SDU at transmission time 420, the UE 115 may calculate the packet delay 415 of the SDU as the difference between the transmission time 420 and the arrival time 425 (e.g., T_wait=T_First−T_Arrival).

The airtime 410 may represent the time difference between the first reception time 430 of the first MAC PDU containing the MAC-CE or buffer status report of the SDU (e.g., even if unsuccessful) to the successful reception of the last MAC PDU containing data from the SDU at last reception time 435. For example, the network entity 105 may receive a first MAC PDU containing a first subset of data from the SDU and store the first reception time 430. The network entity 105 may continue to receive MAC PDUs containing data from the SDU. Based on receiving the final MAC PDU containing data from the SDU, the network entity 105 may calculate the airtime 410 as the difference between the first reception time 430 of the first MAC PDU and the last reception time 435 of the last MAC PDU (e.g., T_Air=first reception time 430—last reception time 435).

In some examples, however, the packet delay 415 may not be known at the network entity 105, which may prohibit the network entity 105 from calculating the packet delay 415 of uplink packets at the UE 115. As such, if the UE 115 is experiencing a packet delay 415 that is relatively large, then the uplink delay 405 experienced in the communications system may be increased.

The packet delay 415 may be an example of the remaining packet delay budget described herein. Further, the network entity 105 may configure one or more contentions associated with each contention-based resource set of multiple contention-based resource sets with packet delay thresholds, where the packet delay thresholds may be compared to the packet delay 415 (e.g., remaining packet delay budgets) of the UE 115. As such, if the packet delay 415 of the UE 115 has a packet delay 415 that satisfies one or more packet delay thresholds of a contention-based resource set, the UE 115 may randomly select a resource from the contention-based resource set. The UE 115 may transmit, using the selected resource, a scheduling request to the network entity 105. In this way, the UE 115 may be able to receive uplink resources for a XR or URLLC uplink transmission in a timely manner. Additionally, the network entity 105 may be able to infer, based on the selected resource from the contention-based resource set, the value of the packet delay 415 experienced at the UE 115.

FIG. 5 illustrates an example of a process flow 500 that supports contention-based scheduling request resources in accordance with one or more aspects of the present disclosure. Aspects of the process flow 500 may implement, or be implemented by, aspects of the wireless communications system 100, the network architecture 200, the wireless communications system 300, and the timing diagram 400. For example, the process flow 500 may include a network entity 105-b, a UE 115-d, and a UE 115-c, which may be examples of corresponding devices described herein with reference to FIGS. 1 through 4. In the following description of the process flow 500, the operations may be performed in a different order than the order shown. Specific operations also may be left out of the process flow 500, or other operations may be added to the process flow 500. Further, although some operations or signaling may be shown to occur at different times for discussion purposes, these operations may actually occur at the same time.

At 505, the network entity 105-b may transmit, to the UE 115-e and the UE 115-d, a message indicating multiple contention-based resource sets dedicated for scheduling requests, where each contention-based resource set of the multiple contention-based resource sets is associated with one or more respective conditions. In some examples, the contention-based resource sets may be a periodic resource set. Further the contention-based resource sets may be used to transmit scheduling requests associated with XR uplink communications, URLLC communications, or both.

At 510, the network entity 105-b may optionally transmit control signaling to the UE 115-e and the UE 115-d. The control signaling may be RRC signaling that indicates the multiple contention-based resource sets and the one or more respective conditions associated with each contention-based resource set. Further, the control signaling may be an example of L1 or L2 signaling that activates the use of the multiple contention-based resource sets. In some examples, the network entity 105-a may transmit, via the control signaling, an indication of a probability function associated with a remaining packet delay budget at the UEs 115.

At 515-a, the UE 115-e may determine to use a first contention-based resource set out of the multiple contention-based resource sets for transmission of a scheduling request. For example, the UE 115-e may compare a remaining packet delay budget of an uplink message with one or more packet delay thresholds of the first contention-based resource set, and may use a contention-based resource set of the multiple based on the remaining packet delay budget satisfying the one or more packet delay thresholds associated with the contention-based resource set. In another example, the UE 115-e may compare a size of the buffer status report threshold with one or more buffer status thresholds of the first contention-based resource set, and may use the first contention-based resource set based on satisfying the one or more buffer status thresholds. In some other examples, the UE 115-e may compute a probability using the indicated probability function and the remaining packet delay budget and compare the computed probability to one or more probability thresholds. As such, the UE 115-e may use the resources of the first contention-based resource set based on the computed probability satisfying the associated probability threshold of the first contention-based resource set. In some other examples, the UE 115-e may determine to use the first contention-based resource set based on the uplink message at the UE 115-e being associated with a logical channel that satisfies the logical channel condition for the first contention-based resource set. At 515-b, the UE 115-d may perform similar determinations as of those of UE 115-e.

At 520-a, in response to determining the first contention-based resource set, the UE 115-e may perform a contention-based procedure. For example, the UE 115-c may randomly select a resource from the first contention-based resource set. Likewise, at 520-b, the UE 115-d may randomly select a resource from the determined contention-based resource set.

At 525, the UE 115-e may transmit, using the randomly selected resource, a scheduling request to request uplink resources for the uplink message (e.g., XR or URLLC uplink message). In such examples, the UE 115-e may transmit the scheduling request using a cyclic shift that is mapped to the C-RNTI of the UE 115-e.

At 530, the UE 115-d may transmit, using the randomly selected resource, a scheduling request to request uplink resources for the uplink message (e.g., XR or URLLC uplink message). In such examples, the UE 115-d may transmit the scheduling request using a cyclic shift that is mapped to the C-RNTI of the UE 115-e.

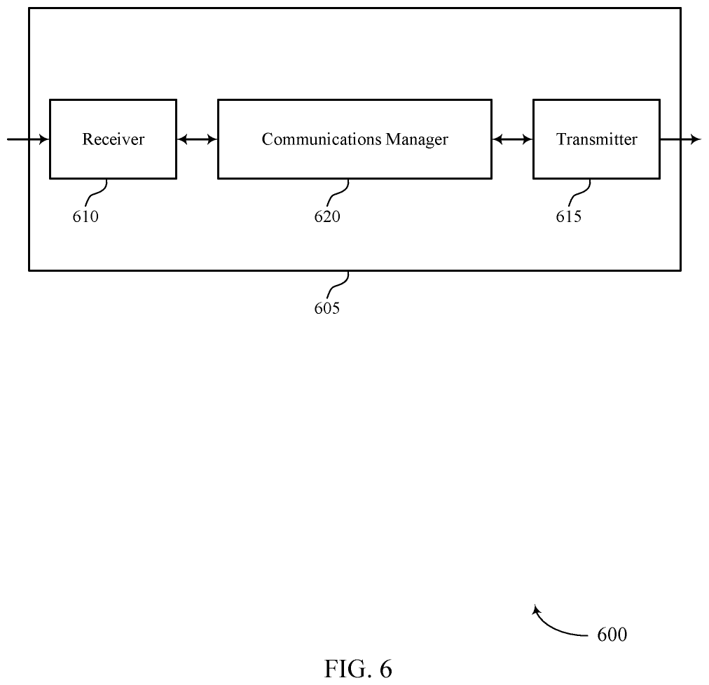

FIG. 6 illustrates a block diagram 600 of a device 605 that supports contention-based scheduling request resources in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to contention-based scheduling request resources). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to contention-based scheduling request resources). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of contention-based scheduling request resources as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. For example, the communications manager 620 may be configured as or otherwise support a means for receiving a message indicating a set of multiple contention-based resource sets dedicated for scheduling requests, each contention-based resource set of the set of multiple contention-based resource sets being associated with one or more respective conditions. The communications manager 620 may be configured as or otherwise support a means for transmitting a scheduling request to request uplink resources for the UE using a resource of a contention-based resource set of the set of multiple contention-based resource sets based on satisfaction of the one or more respective conditions for the contention-based resource set and on a successful contention-based procedure for the contention-based resource set.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for using contention-based resource sets for transmission of scheduling requests, which may be a more efficient utilization of communication resources.

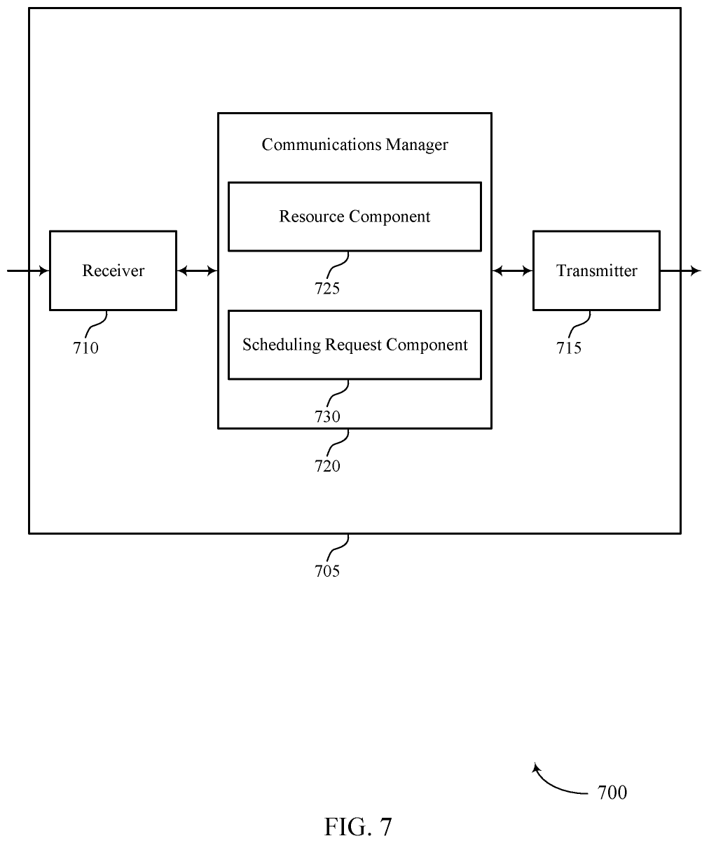

FIG. 7 illustrates a block diagram 700 of a device 705 that supports contention-based scheduling request resources in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to contention-based scheduling request resources). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to contention-based scheduling request resources). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of contention-based scheduling request resources as described herein. For example, the communications manager 720 may include a resource component 725 a scheduling request component 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. The resource component 725 may be configured as or otherwise support a means for receiving a message indicating a set of multiple contention-based resource sets dedicated for scheduling requests, each contention-based resource set of the set of multiple contention-based resource sets being associated with one or more respective conditions. The scheduling request component 730 may be configured as or otherwise support a means for transmitting a scheduling request to request uplink resources for the UE using a resource of a contention-based resource set of the set of multiple contention-based resource sets based on satisfaction of the one or more respective conditions for the contention-based resource set and on a successful contention-based procedure for the contention-based resource set.

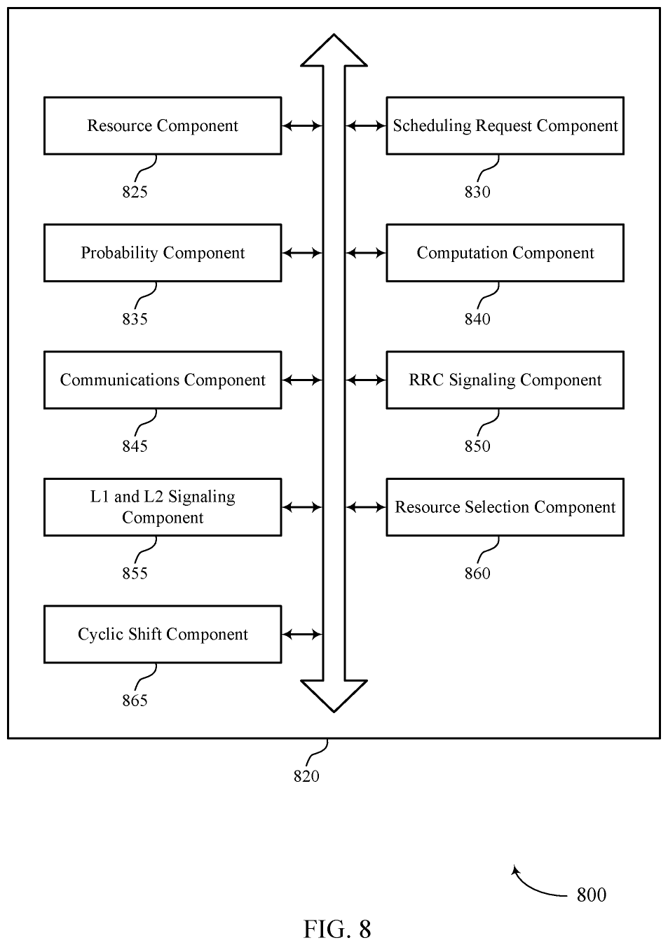

FIG. 8 illustrates a block diagram 800 of a communications manager 820 that supports contention-based scheduling request resources in accordance with one or more aspects of the present disclosure. The communications manager 820 may be an example of aspects of a communications manager 620, a communications manager 720, or both, as described herein. The communications manager 820, or various components thereof, may be an example of means for performing various aspects of contention-based scheduling request resources as described herein. For example, the communications manager 820 may include a resource component 825, a scheduling request component 830, a probability component 835, a computation component 840, a communications component 845, an RRC signaling component 850, a L1 and L2 signaling component 855, a resource selection component 860, a cyclic shift component 865, or any combination thereof. Each of these components may communicate, directly or indirectly, with one another (e.g., via one or more buses).

The communications manager 820 may support wireless communication at a UE in accordance with examples as disclosed herein. The resource component 825 may be configured as or otherwise support a means for receiving a message indicating a set of multiple contention-based resource sets dedicated for scheduling requests, each contention-based resource set of the set of multiple contention-based resource sets being associated with one or more respective conditions. The scheduling request component 830 may be configured as or otherwise support a means for transmitting a scheduling request to request uplink resources for the UE using a resource of a contention-based resource set of the set of multiple contention-based resource sets based on satisfaction of the one or more respective conditions for the contention-based resource set and on a successful contention-based procedure for the contention-based resource set.

In some examples, to support transmitting the scheduling request, the scheduling request component 830 may be configured as or otherwise support a means for transmitting, using the resource of the contention-based resource set, the scheduling request based on a remaining packet delay budget of an uplink message associated with the scheduling request being greater than a packet delay threshold, where the satisfaction of the one or more respective conditions of the contention-based resource set includes the remaining packet delay budget being greater than the packet delay threshold.

In some examples, to support transmitting the scheduling request, the scheduling request component 830 may be configured as or otherwise support a means for transmitting, using the resource of the contention-based resource set, the scheduling request based on a remaining packet delay budget of an uplink message associated with the scheduling request being greater than a first packet delay threshold and being less than a second packet delay threshold, where the satisfaction of the one or more respective conditions of the contention-based resource set includes the remaining packet delay budget being greater than the first packet delay threshold and less than the second packet delay threshold.

In some examples, to support transmitting the scheduling request, the scheduling request component 830 may be configured as or otherwise support a means for transmitting, using the resource of the contention-based resource set, the scheduling request based on a buffer size of the UE being greater than a buffer size threshold, where the satisfaction of the one or more respective conditions of the contention-based resource set includes the buffer size of the UE being greater than the buffer size threshold.

In some examples, to support transmitting the scheduling request, the scheduling request component 830 may be configured as or otherwise support a means for transmitting, using the resource of the contention-based resource set, the scheduling request based on a buffer size of the UE being less than a buffer size threshold, where the satisfaction of the one or more respective conditions of the contention-based resource set includes the buffer size of the UE being less than the buffer size threshold.

In some examples, to support transmitting the scheduling request, the scheduling request component 830 may be configured as or otherwise support a means for transmitting, using the resource of the contention-based resource set, the scheduling request based on a buffer size of the UE being greater than a first buffer size threshold and being less than a second buffer size threshold, where the satisfaction of the one or more respective conditions of the contention-based resource set includes the buffer size of the UE being greater than the first buffer size threshold and less than the second buffer size threshold.

In some examples, the probability component 835 may be configured as or otherwise support a means for receiving an indication of a probability function associated with the set of multiple contention-based resource sets, the probability function being associated with a packet delay time of the UE. In some examples, the computation component 840 may be configured as or otherwise support a means for computing a probability using the probability function and the packet delay time of the UE, where transmitting the scheduling request using the resource of the contention-based resource set is based on the probability satisfying a probability threshold of the contention-based resource set.

In some examples, the communications component 845 may be configured as or otherwise support a means for receiving an indication of the one or more respective conditions associated with each contention-based resource set of the set of multiple contention-based resource sets.

In some examples, the RRC signaling component 850 may be configured as or otherwise support a means for receiving a RRC message indicating the set of multiple contention-based resource sets. In some examples, the L1 and L2 signaling component 855 may be configured as or otherwise support a means for receiving a L1 or L2 signal indicating activation of the set of multiple contention-based resource sets.

In some examples, to support transmitting the scheduling request, the resource selection component 860 may be configured as or otherwise support a means for transmitting, using the resource of the contention-based resource set, the scheduling request based on a random selection of the resource from the contention-based resource set, where the successful contention-based procedure includes the random selection of the resource from the contention-based resource set.

In some examples, to support transmitting the scheduling request, the cyclic shift component 865 may be configured as or otherwise support a means for transmitting the scheduling request using a cyclic shift that is mapped to a radio network temporary identifier of the UE.

In some examples, the set of multiple contention-based resource sets are periodic.

In some examples, each contention-based resource set of the set of multiple contention-based resource sets is associated with a respective logical channel.

In some examples, the uplink resources are for an uplink message that includes a XR uplink message or a ultra-reliable low latency communication uplink message.

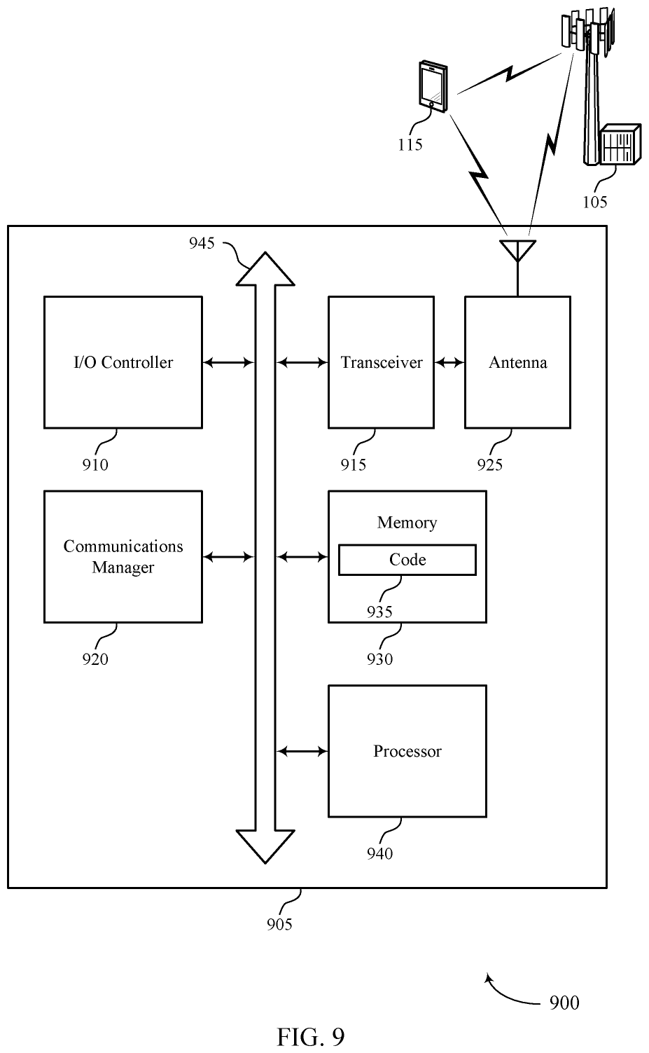

FIG. 9 illustrates a diagram of a system 900 including a device 905 that supports contention-based scheduling request resources in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting contention-based scheduling request resources). For example, the device 905 or a component of the device 905 may include a processor 940 and memory 930 coupled with or to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for receiving a message indicating a set of multiple contention-based resource sets dedicated for scheduling requests, each contention-based resource set of the set of multiple contention-based resource sets being associated with one or more respective conditions. The communications manager 920 may be configured as or otherwise support a means for transmitting a scheduling request to request uplink resources for the UE using a resource of a contention-based resource set of the set of multiple contention-based resource sets based on satisfaction of the one or more respective conditions for the contention-based resource set and on a successful contention-based procedure for the contention-based resource set.

By including or configuring the communications manager 920 in accordance with examples as described herein, the device 905 may support techniques for using contention-based resource sets for transmission of scheduling requests, which may reduce latency and be a more efficient utilization of communication resources.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of contention-based scheduling request resources as described herein, or the processor 940 and the memory 930 may be otherwise configured to perform or support such operations.

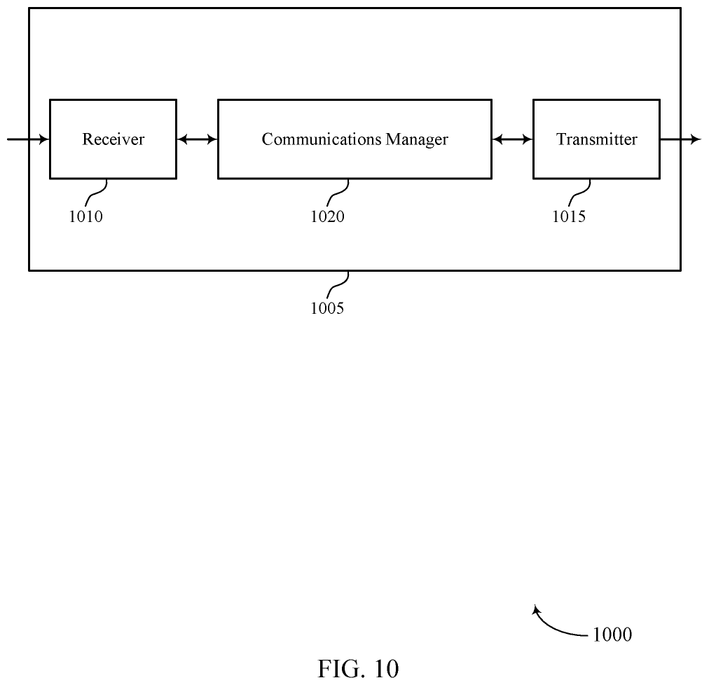

FIG. 10 illustrates a block diagram 1000 of a device 1005 that supports contention-based scheduling request resources in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of contention-based scheduling request resources as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. For example, the communications manager 1020 may be configured as or otherwise support a means for transmitting a message indicating a set of multiple contention-based resource sets dedicated for scheduling requests for one or more UEs, each contention-based resource set of the set of multiple contention-based resource sets being associated with one or more respective conditions. The communications manager 1020 may be configured as or otherwise support a means for receiving, via a resource of a contention-based resource set of the set of multiple contention-based resource sets, a scheduling request that requests uplink resources from a first UE, the contention-based resource set being based on satisfaction of the one or more respective conditions for the contention-based resource set at the first UE and on a successful contention-based procedure for the contention-based resource set at the first UE.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for using contention-based resource sets for transmission of scheduling requests, which may be a more efficient utilization of communication resources.

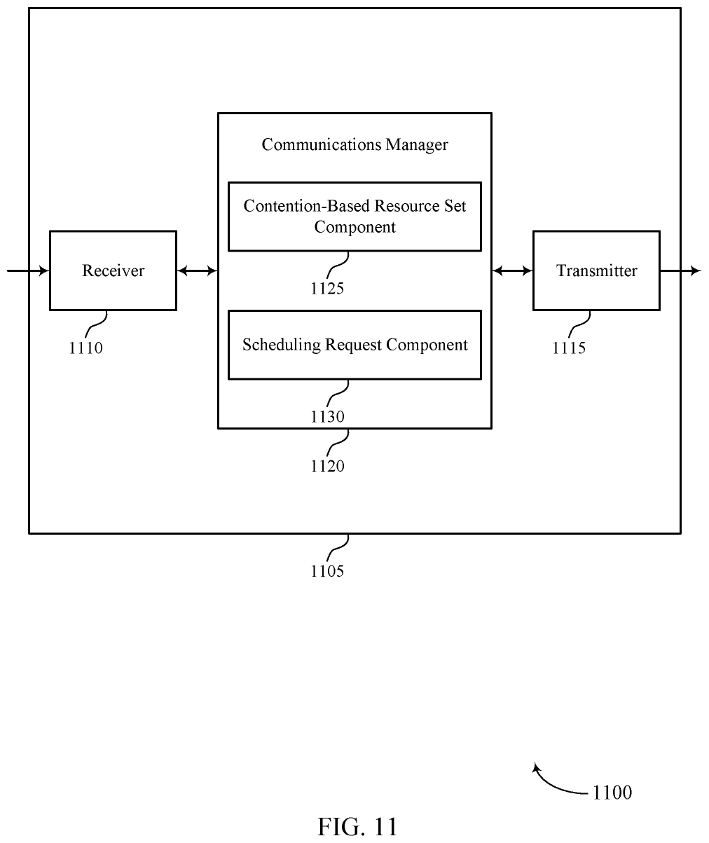

FIG. 11 illustrates a block diagram 1100 of a device 1105 that supports contention-based scheduling request resources in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of contention-based scheduling request resources as described herein. For example, the communications manager 1120 may include a contention-based resource set component 1125 a scheduling request component 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. The contention-based resource set component 1125 may be configured as or otherwise support a means for transmitting a message indicating a set of multiple contention-based resource sets dedicated for scheduling requests for one or more UEs, each contention-based resource set of the set of multiple contention-based resource sets being associated with one or more respective conditions. The scheduling request component 1130 may be configured as or otherwise support a means for receiving, via a resource of a contention-based resource set of the set of multiple contention-based resource sets, a scheduling request that requests uplink resources from a first UE, the contention-based resource set being based on satisfaction of the one or more respective conditions for the contention-based resource set at the first UE and on a successful contention-based procedure for the contention-based resource set at the first UE.

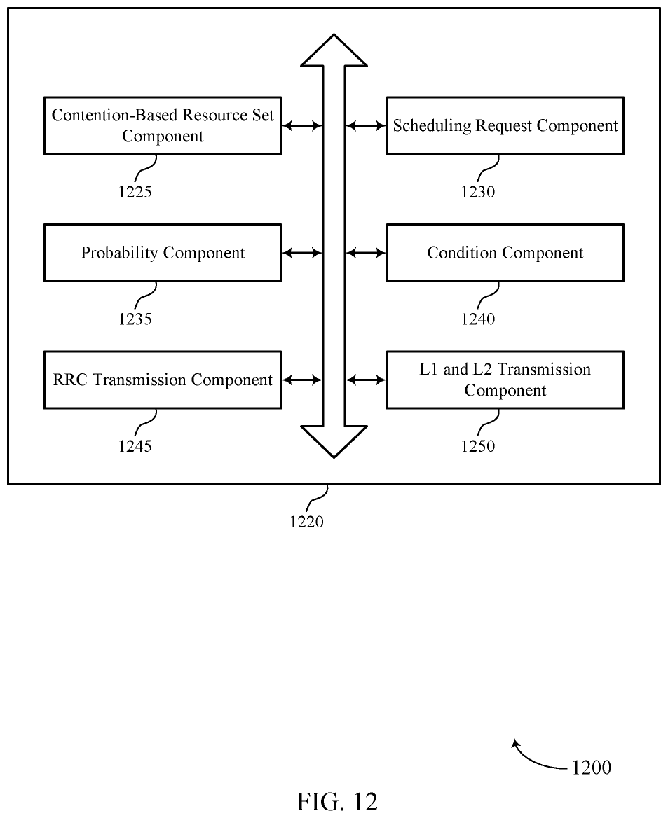

FIG. 12 illustrates a block diagram 1200 of a communications manager 1220 that supports contention-based scheduling request resources in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of contention-based scheduling request resources as described herein. For example, the communications manager 1220 may include a contention-based resource set component 1225, a scheduling request component 1230, a probability component 1235, a condition component 1240, an RRC transmission component 1245, a L1 and L2 transmission component 1250, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication at a network entity in accordance with examples as disclosed herein. The contention-based resource set component 1225 may be configured as or otherwise support a means for transmitting a message indicating a set of multiple contention-based resource sets dedicated for scheduling requests for one or more UEs, each contention-based resource set of the set of multiple contention-based resource sets being associated with one or more respective conditions. The scheduling request component 1230 may be configured as or otherwise support a means for receiving, via a resource of a contention-based resource set of the set of multiple contention-based resource sets, a scheduling request that requests uplink resources from a first UE, the contention-based resource set being based on satisfaction of the one or more respective conditions for the contention-based resource set at the first UE and on a successful contention-based procedure for the contention-based resource set at the first UE.

In some examples, to support receiving the scheduling request, the scheduling request component 1230 may be configured as or otherwise support a means for receiving, via the resource of the contention-based resource set, the scheduling request based on a remaining packet delay budget of an uplink message associated with the scheduling request being greater than a packet delay threshold, where the satisfaction of the one or more respective conditions of the contention-based resource set includes the remaining packet delay budget of the first UE being greater than the packet delay threshold.

In some examples, to support receiving the scheduling request, the scheduling request component 1230 may be configured as or otherwise support a means for receiving, via the resource of the contention-based resource set, the scheduling request based on a remaining packet delay budget of an uplink message associated with the scheduling request being greater than a first packet delay threshold and being less than a second packet delay threshold, where the satisfaction of the one or more respective conditions of the contention-based resource set includes the remaining packet delay budget of the first UE being greater than the first packet delay threshold and less than the second packet delay threshold.

In some examples, to support receiving the scheduling request, the scheduling request component 1230 may be configured as or otherwise support a means for receiving, via the resource of the contention-based resource set, the scheduling request based on a buffer size of the first UE being greater than a buffer size threshold, where the satisfaction of the one or more respective conditions of the contention-based resource set includes the buffer size of the first UE being greater than the buffer size threshold.

In some examples, to support receiving the scheduling request, the scheduling request component 1230 may be configured as or otherwise support a means for receiving, via the resource of the contention-based resource set, the scheduling request based on a buffer size of the first UE being less than a buffer size threshold, where the satisfaction of the one or more respective conditions of the contention-based resource set includes the buffer size of the first UE being less than the buffer size threshold.

In some examples, to support receiving the scheduling request, the scheduling request component 1230 may be configured as or otherwise support a means for receiving, using the resource of the contention-based resource set, the scheduling request based on a buffer size of the first UE being greater than a first buffer size threshold and being less than a second buffer size threshold, where the satisfaction of the one or more respective conditions of the contention-based resource set includes the buffer size of the first UE being greater than the first buffer size threshold and less than the second buffer size threshold.

In some examples, the probability component 1235 may be configured as or otherwise support a means for transmitting an indication of a probability function associated with the set of multiple contention-based resource sets, the probability function being based on a packet delay time of each UE of the one or more UEs, where receiving the scheduling request via the resource of the contention-based resource set is based on a computed probability of the first UE satisfying a probability threshold of the contention-based resource set.

In some examples, the condition component 1240 may be configured as or otherwise support a means for transmitting an indication of the one or more respective conditions associated with each contention-based resource set of the set of multiple contention-based resource sets.

In some examples, the RRC transmission component 1245 may be configured as or otherwise support a means for transmitting a RRC message indicating the set of multiple contention-based resource sets. In some examples, the L1 and L2 transmission component 1250 may be configured as or otherwise support a means for transmitting a L1 or L2 signal indicating activation of the set of multiple contention-based resource sets.

In some examples, to support receiving the scheduling request, the scheduling request component 1230 may be configured as or otherwise support a means for receiving, via the resource of the contention-based resource set, the scheduling request based on a random selection of the resource from the contention-based resource set by the first UE, where the successful contention-based procedure includes the random selection of the resource from the contention-based resource set by the first UE.

In some examples, to support receiving the scheduling request, the scheduling request component 1230 may be configured as or otherwise support a means for receiving the scheduling request that is associated with a cyclic shift that is mapped to a radio network temporary identifier of the first UE.

In some examples, the set of multiple contention-based resource sets are periodic.

In some examples, each contention-based resource set of the set of multiple contention-based resource sets is associated with a respective logical channel.

In some examples, the uplink resources are for an uplink message that includes a XR uplink message or a ultra-reliable low latency communication uplink message.

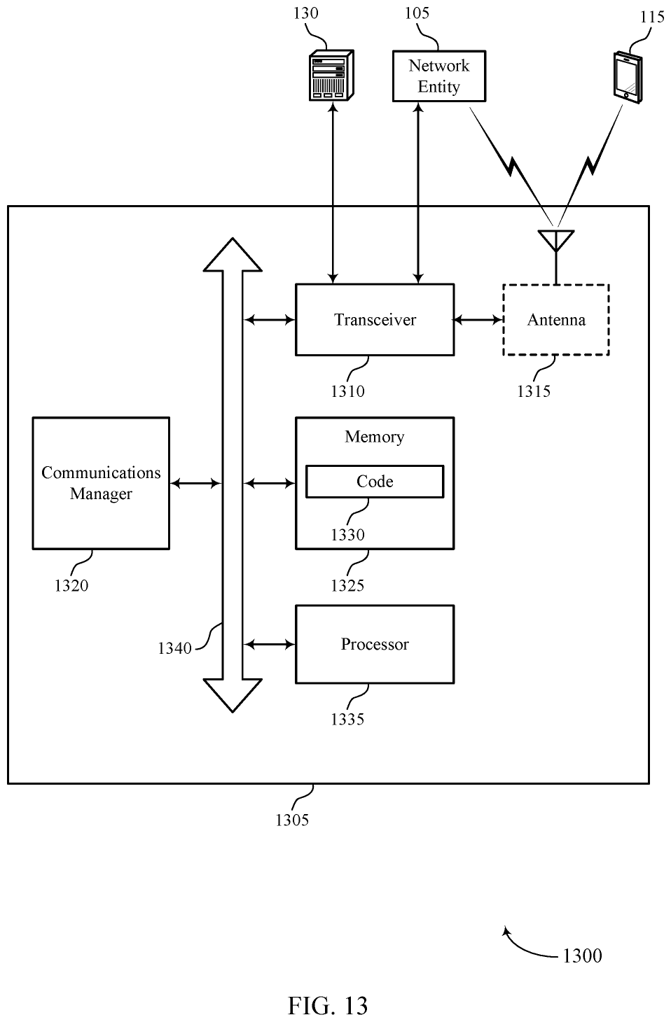

FIG. 13 illustrates a diagram of a system 1300 including a device 1305 that supports contention-based scheduling request resources in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting contention-based scheduling request resources). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication at a network entity in accordance with examples as disclosed herein. For example, the communications manager 1320 may be configured as or otherwise support a means for transmitting a message indicating a set of multiple contention-based resource sets dedicated for scheduling requests for one or more UEs, each contention-based resource set of the set of multiple contention-based resource sets being associated with one or more respective conditions. The communications manager 1320 may be configured as or otherwise support a means for receiving, via a resource of a contention-based resource set of the set of multiple contention-based resource sets, a scheduling request that requests uplink resources from a first UE, the contention-based resource set being based on satisfaction of the one or more respective conditions for the contention-based resource set at the first UE and on a successful contention-based procedure for the contention-based resource set at the first UE.

By including or configuring the communications manager 1320 in accordance with examples as described herein, the device 1305 may support techniques for using contention-based resource sets for transmission of scheduling requests, which may reduce latency and be a more efficient utilization of communication resources.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of contention-based scheduling request resources as described herein, or the processor 1335 and the memory 1325 may be otherwise configured to perform or support such operations.

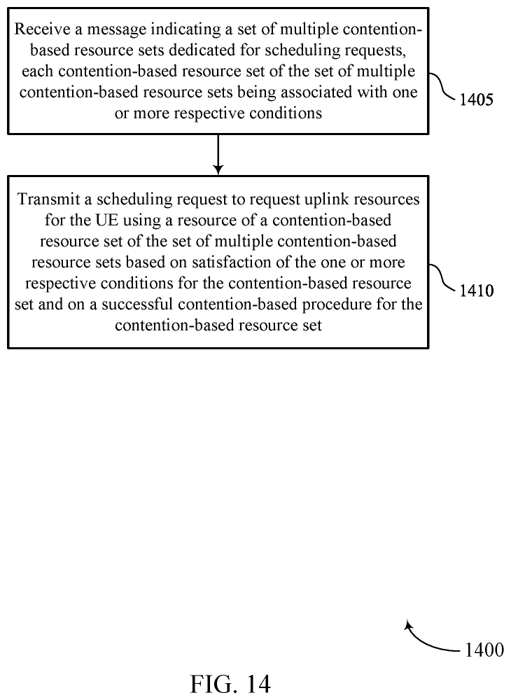

FIG. 14 illustrates a flowchart showing a method 1400 that supports contention-based scheduling request resources in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving a message indicating a set of multiple contention-based resource sets dedicated for scheduling requests, each contention-based resource set of the set of multiple contention-based resource sets being associated with one or more respective conditions. The operations of 1405 may be performed in accordance with examples as disclosed herein. In some examples, aspects of the operations of 1405 may be performed by a resource component 825 as described with reference to FIG. 8.

At 1410, the method may include transmitting a scheduling request to request uplink resources for the UE using a resource of a contention-based resource set of the set of multiple contention-based resource sets based on satisfaction of the one or more respective conditions for the contention-based resource set and on a successful contention-based procedure for the contention-based resource set. The operations of 1410 may be performed in accordance with examples as disclosed herein. In some examples, aspects of the operations of 1410 may be performed by a scheduling request component 830 as described with reference to FIG. 8.

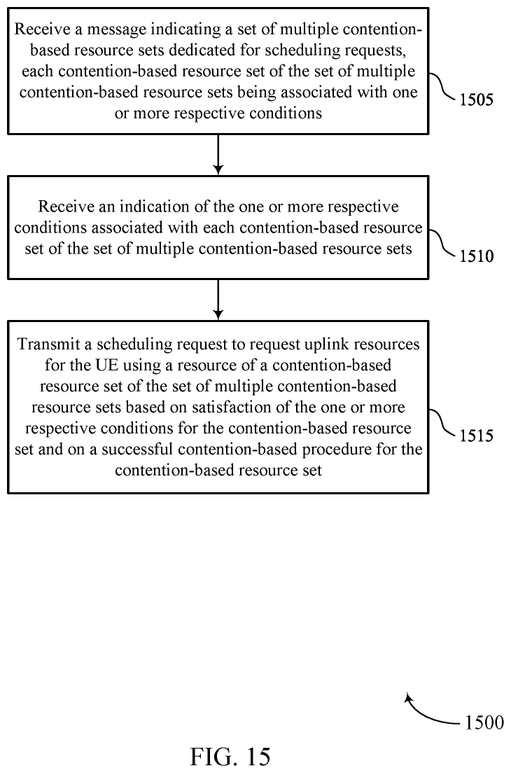

FIG. 15 illustrates a flowchart showing a method 1500 that supports contention-based scheduling request resources in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving a message indicating a set of multiple contention-based resource sets dedicated for scheduling requests, each contention-based resource set of the set of multiple contention-based resource sets being associated with one or more respective conditions. The operations of 1505 may be performed in accordance with examples as disclosed herein. In some examples, aspects of the operations of 1505 may be performed by a resource component 825 as described with reference to FIG. 8.

At 1510, the method may include receiving an indication of the one or more respective conditions associated with each contention-based resource set of the set of multiple contention-based resource sets. The operations of 1510 may be performed in accordance with examples as disclosed herein. In some examples, aspects of the operations of 1510 may be performed by a communications component 845 as described with reference to FIG. 8.

At 1515, the method may include transmitting a scheduling request to request uplink resources for the UE using a resource of a contention-based resource set of the set of multiple contention-based resource sets based on satisfaction of the one or more respective conditions for the contention-based resource set and on a successful contention-based procedure for the contention-based resource set. The operations of 1515 may be performed in accordance with examples as disclosed herein. In some examples, aspects of the operations of 1515 may be performed by a scheduling request component 830 as described with reference to FIG. 8.

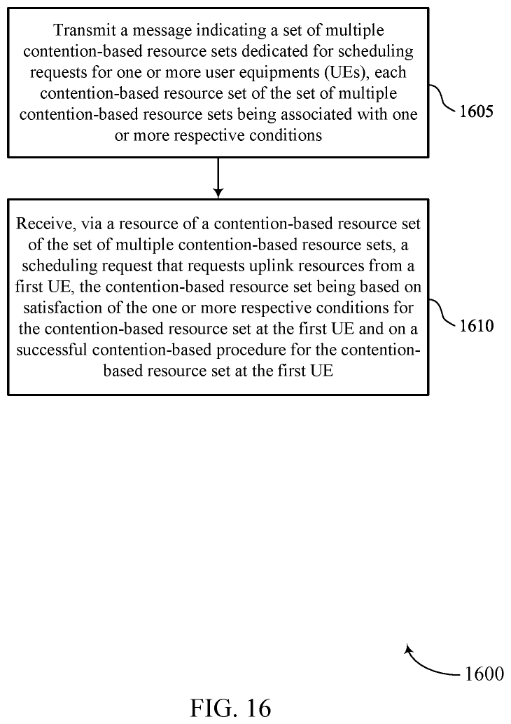

FIG. 16 illustrates a flowchart showing a method 1600 that supports contention-based scheduling request resources in accordance with one or more aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include transmitting a message indicating a set of multiple contention-based resource sets dedicated for scheduling requests for one or more UEs, each contention-based resource set of the set of multiple contention-based resource sets being associated with one or more respective conditions. The operations of 1605 may be performed in accordance with examples as disclosed herein. In some examples, aspects of the operations of 1605 may be performed by a contention-based resource set component 1225 as described with reference to FIG. 12.

At 1610, the method may include receiving, via a resource of a contention-based resource set of the set of multiple contention-based resource sets, a scheduling request that requests uplink resources from a first UE, the contention-based resource set being based on satisfaction of the one or more respective conditions for the contention-based resource set at the first UE and on a successful contention-based procedure for the contention-based resource set at the first UE. The operations of 1610 may be performed in accordance with examples as disclosed herein. In some examples, aspects of the operations of 1610 may be performed by a scheduling request component 1230 as described with reference to FIG. 12.

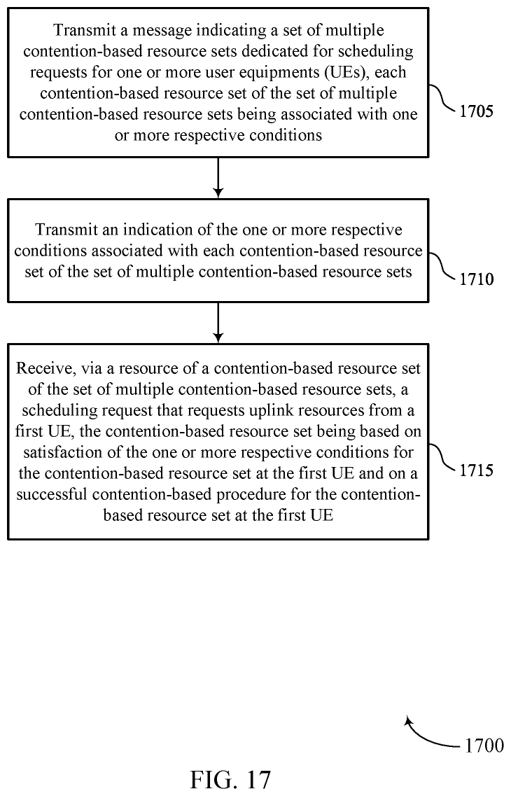

FIG. 17 illustrates a flowchart showing a method 1700 that supports contention-based scheduling request resources in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include transmitting a message indicating a set of multiple contention-based resource sets dedicated for scheduling requests for one or more UEs, each contention-based resource set of the set of multiple contention-based resource sets being associated with one or more respective conditions. The operations of 1705 may be performed in accordance with examples as disclosed herein. In some examples, aspects of the operations of 1705 may be performed by a contention-based resource set component 1225 as described with reference to FIG. 12.

At 1710, the method may include transmitting an indication of the one or more respective conditions associated with each contention-based resource set of the set of multiple contention-based resource sets. The operations of 1710 may be performed in accordance with examples as disclosed herein. In some examples, aspects of the operations of 1710 may be performed by a condition component 1240 as described with reference to FIG. 12.

At 1715, the method may include receiving, via a resource of a contention-based resource set of the set of multiple contention-based resource sets, a scheduling request that requests uplink resources from a first UE, the contention-based resource set being based on satisfaction of the one or more respective conditions for the contention-based resource set at the first UE and on a successful contention-based procedure for the contention-based resource set at the first UE. The operations of 1715 may be performed in accordance with examples as disclosed herein. In some examples, aspects of the operations of 1715 may be performed by a scheduling request component 1230 as described with reference to FIG. 12.

The following provides an overview of aspects of the present disclosure:
Aspect 1: A method for wireless communication at a UE, comprising: receiving a message indicating a plurality of contention-based resource sets dedicated for scheduling requests, each contention-based resource set of the plurality of contention-based resource sets being associated with one or more respective conditions; and transmitting a scheduling request to request uplink resources for the UE using a resource of a contention-based resource set of the plurality of contention-based resource sets based at least in part on satisfaction of the one or more respective conditions for the contention-based resource set and on a successful contention-based procedure for the contention-based resource set.
Aspect 2: The method of aspect 1, wherein transmitting the scheduling request comprises: transmitting, using the resource of the contention-based resource set, the scheduling request based at least in part on a remaining packet delay budget of an uplink message associated with the scheduling request being greater than a packet delay threshold, wherein the satisfaction of the one or more respective conditions of the contention-based resource set comprises the remaining packet delay budget being greater than the packet delay threshold.
Aspect 3: The method of any of aspects 1 through 2, wherein transmitting the scheduling request comprises: transmitting, using the resource of the contention-based resource set, the scheduling request based at least in part on a remaining packet delay budget of an uplink message associated with the scheduling request being greater than a first packet delay threshold and being less than a second packet delay threshold, wherein the satisfaction of the one or more respective conditions of the contention-based resource set comprises the remaining packet delay budget being greater than the first packet delay threshold and less than the second packet delay threshold.
Aspect 4: The method of any of aspects 1 through 3, wherein transmitting the scheduling request comprises: transmitting, using the resource of the contention-based resource set, the scheduling request based at least in part on a buffer size of the UE being greater than a buffer size threshold, wherein the satisfaction of the one or more respective conditions of the contention-based resource set comprises the buffer size of the UE being greater than the buffer size threshold.
Aspect 5: The method of any of aspects 1 through 4, wherein transmitting the scheduling request comprises: transmitting, using the resource of the contention-based resource set, the scheduling request based at least in part on a buffer size of the UE being less than a buffer size threshold, wherein the satisfaction of the one or more respective conditions of the contention-based resource set comprises the buffer size of the UE being less than the buffer size threshold.
Aspect 6: The method of any of aspects 1 through 5, wherein transmitting the scheduling request comprises: transmitting, using the resource of the contention-based resource set, the scheduling request based at least in part on a buffer size of the UE being greater than a first buffer size threshold and being less than a second buffer size threshold, wherein the satisfaction of the one or more respective conditions of the contention-based resource set comprises the buffer size of the UE being greater than the first buffer size threshold and less than the second buffer size threshold.
Aspect 7: The method of any of aspects 1 through 6, further comprising:

receiving an indication of a probability function associated with the plurality of contention-based resource sets, the probability function being associated with a packet delay time of the UE; and computing a probability using the probability function and the packet delay time of the UE, wherein transmitting the scheduling request using the resource of the contention-based resource set is based at least in part on the probability satisfying a probability threshold of the contention-based resource set.
Aspect 8: The method of any of aspects 1 through 7, further comprising: receiving an indication of the one or more respective conditions associated with each contention-based resource set of the plurality of contention-based resource sets.
Aspect 9: The method of any of aspects 1 through 8, further comprising: receiving a RRC message indicating the plurality of contention-based resource sets; and receiving a L1 or L2 signal indicating activation of the plurality of contention-based resource sets.
Aspect 10: The method of any of aspects 1 through 9, wherein transmitting the scheduling request comprises: transmitting, using the resource of the contention-based resource set, the scheduling request based at least in part on a random selection of the resource from the contention-based resource set, wherein the successful contention-based procedure comprises the random selection of the resource from the contention-based resource set.
Aspect 11: The method of any of aspects 1 through 10, wherein transmitting the scheduling request comprises: transmitting the scheduling request using a cyclic shift that is mapped to a RNTI of the UE.
Aspect 12: The method of any of aspects 1 through 11, wherein the plurality of contention-based resource sets are periodic.

Aspect 13: The method of any of aspects 1 through 12, wherein each contention-based resource set of the plurality of contention-based resource sets is associated with a respective logical channel.
Aspect 14: The method of any of aspects 1 through 13, wherein the uplink resources are for an uplink message that comprises a XR uplink message or a URLLC uplink message.
Aspect 15: A method for wireless communication at a network entity, comprising: transmitting a message indicating a plurality of contention-based resource sets dedicated for scheduling requests for one or more UEs, each contention-based resource set of the plurality of contention-based resource sets being associated with one or more respective conditions; and receiving, via a resource of a contention-based resource set of the plurality of contention-based resource sets, a scheduling request that requests uplink resources from a first UE, the contention-based resource set being based at least in part on satisfaction of the one or more respective conditions for the contention-based resource set at the first UE and on a successful contention-based procedure for the contention-based resource set at the first UE.
Aspect 16: The method of aspect 15, wherein receiving the scheduling request comprises: receiving, via the resource of the contention-based resource set, the scheduling request based at least in part on a remaining packet delay budget of an uplink message associated with the scheduling request being greater than a packet delay threshold, wherein the satisfaction of the one or more respective conditions of the contention-based resource set comprises the remaining packet delay budget of the first UE being greater than the packet delay threshold.
Aspect 17: The method of any of aspects 15 through 16, wherein receiving the scheduling request comprises: receiving, via the resource of the contention-based resource set, the scheduling request based at least in part on a remaining packet delay budget of an uplink message associated with the scheduling request being greater than a first packet delay threshold and being less than a second packet delay threshold, wherein the satisfaction of the one or more respective conditions of the contention-based resource set comprises the remaining packet delay budget of the first UE being greater than the first packet delay threshold and less than the second packet delay threshold.
Aspect 18: The method of any of aspects 15 through 17, wherein receiving the scheduling request comprises: receiving, via the resource of the contention-based resource set, the scheduling request based at least in part on a buffer size of the first UE being greater than a buffer size threshold, wherein the satisfaction of the one or more respective conditions of the contention-based resource set comprises the buffer size of the first UE being greater than the buffer size threshold.
Aspect 19: The method of any of aspects 15 through 18, wherein receiving the scheduling request comprises: receiving, via the resource of the contention-based resource set, the scheduling request based at least in part on a buffer size of the first UE being less than a buffer size threshold, wherein the satisfaction of the one or more respective conditions of the contention-based resource set comprises the buffer size of the first UE being less than the buffer size threshold.
Aspect 20: The method of any of aspects 15 through 19, wherein receiving the scheduling request comprises: receiving, using the resource of the contention-based resource set, the scheduling request based at least in part on a buffer size of the first UE being greater than a first buffer size threshold and being less than a second buffer size threshold, wherein the satisfaction of the one or more respective conditions of the contention-based resource set comprises the buffer size of the first UE being greater than the first buffer size threshold and less than the second buffer size threshold.
Aspect 21: The method of any of aspects 15 through 20, further comprising: transmitting an indication of a probability function associated with the plurality of contention-based resource sets, the probability function being based at least in part on a packet delay time of each UE of the one or more UEs, wherein receiving the scheduling request via the resource of the contention-based resource set is based at least in part on a computed probability of the first UE satisfying a probability threshold of the contention-based resource set.
Aspect 22: The method of any of aspects 15 through 21, further comprising: transmitting an indication of the one or more respective conditions associated with each contention-based resource set of the plurality of contention-based resource sets.
Aspect 23: The method of any of aspects 15 through 22, further comprising: transmitting a RRC message indicating the plurality of contention-based resource sets;

and transmitting a L1 or L2 signal indicating activation of the plurality of contention-based resource sets.
Aspect 24: The method of any of aspects 15 through 23, wherein receiving the scheduling request comprises: receiving, via the resource of the contention-based contention-based procedure comprises the random selection of the resource from the contention-based resource set by the first UE.
Aspect 25: The method of any of aspects 15 through 24, wherein receiving the scheduling request comprises: receiving the scheduling request that is associated with a cyclic shift that is mapped to a RNTI of the first UE.
Aspect 26: The method of any of aspects 15 through 25, wherein the plurality of contention-based resource sets are periodic.
Aspect 27: The method of any of aspects 15 through 26, wherein each contention-based resource set of the plurality of contention-based resource sets is associated with a respective logical channel.
Aspect 28: The method of any of aspects 15 through 27, wherein the uplink resources are for an uplink message that comprises a XR uplink message or a URLLC uplink message.
Aspect 29: An apparatus for wireless communication at a UE, comprising a processor; memory coupled with the processor; and instructions stored in the memory and executable by the processor to cause the apparatus to perform a method of any of aspects 1 through 14.
Aspect 30: An apparatus for wireless communication at a UE, comprising at least one means for performing a method of any of aspects 1 through 14.
Aspect 31: A non-transitory computer-readable medium storing code for wireless communication at a UE, the code comprising instructions executable by a processor to perform a method of any of aspects 1 through 14.
Aspect 32: An apparatus for wireless communication at a network entity, comprising a processor; memory coupled with the processor; and instructions stored in the memory and executable by the processor to cause the apparatus to perform a method of any of aspects 15 through 28.
Aspect 33: An apparatus for wireless communication at a network entity, comprising at least one means for performing a method of any of aspects 15 through 28.
Aspect 34: A non-transitory computer-readable medium storing code for wireless communication at a network entity, the code comprising instructions executable by a processor to perform a method of any of aspects 15 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer,

The description herein is provided to enable a person having ordinary skill in the art to make or use the disclosure. Various modifications to the disclosure will be or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers.

Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a memory; and
a processor coupled to the memory and configured to:
receive a message indicating a plurality of contention-based resource sets dedicated for scheduling requests, each contention-based resource set of the plurality of contention-based resource sets being associated with one or more respective conditions; and
transmit a scheduling request to request uplink resources for the UE using a resource of a contention-based resource set of the plurality of contention-based resource sets based at least in part on satisfaction of the one or more respective conditions for the contention-based resource set and on a successful contention-based procedure for the contention-based resource set.

2. The apparatus of claim 1, wherein, to transmit the scheduling request, the processor is further configured:
transmit, using the resource of the contention-based resource set, the scheduling request based at least in part on a remaining packet delay budget of an uplink message associated with the scheduling request being greater than a packet delay threshold, wherein the satisfaction of the one or more respective conditions of the contention-based resource set comprises the remaining packet delay budget being greater than the packet delay threshold.

3. The apparatus of claim 1, wherein, to transmit the scheduling request, the processor is further configured:
transmit, using the resource of the contention-based resource set, the scheduling request based at least in part on a remaining packet delay budget of an uplink message associated with the scheduling request being greater than a first packet delay threshold and being less than a second packet delay threshold, wherein the satisfaction of the one or more respective conditions of the contention-based resource set comprises the remaining packet delay budget being greater than the first packet delay threshold and less than the second packet delay threshold.

4. The apparatus of claim 1, wherein, to transmit the scheduling request, the processor is further configured:
transmit, using the resource of the contention-based resource set, the scheduling request based at least in part on a buffer size of the UE being greater than a buffer size threshold, wherein the satisfaction of the one or more respective conditions of the contention-based resource set comprises the buffer size of the UE being greater than the buffer size threshold.

5. The apparatus of claim 1, wherein, to transmit the scheduling request, the processor is further configured:
transmit, using the resource of the contention-based resource set, the scheduling request based at least in part on a buffer size of the UE being less than a buffer size threshold, wherein the satisfaction of the one or more respective conditions of the contention-based resource set comprises the buffer size of the UE being less than the buffer size threshold.

6. The apparatus of claim 1, wherein, to transmit the scheduling request, the processor is further configured:
transmit, using the resource of the contention-based resource set, the scheduling request based at least in part on a buffer size of the UE being greater than a first buffer size threshold and being less than a second buffer size threshold, wherein the satisfaction of the one or more respective conditions of the contention-based resource set comprises the buffer size of the UE being greater than the first buffer size threshold and less than the second buffer size threshold.

7. The apparatus of claim 1, wherein the processor is further configured to:
receive an indication of a probability function associated with the plurality of contention-based resource sets, the probability function being associated with a packet delay time of the UE; and
compute a probability using the probability function and the packet delay time of the UE, wherein transmitting the scheduling request using the resource of the contention-based resource set is based at least in part on the probability satisfying a probability threshold of the contention-based resource set.

8. The apparatus of claim 1, wherein the processor is further configured to:
receive an indication of the one or more respective conditions associated with each contention-based resource set of the plurality of contention-based resource sets.

9. The apparatus of claim 1, wherein the processor is further configured to:
receive a radio resource control message indicating the plurality of contention-based resource sets; and
receive a layer 1 or layer 2 signal indicating activation of the plurality of contention-based resource sets.

10. The apparatus of claim 1, wherein, to transmit the scheduling request, the processor is further configured:
transmit, using the resource of the contention-based resource set, the scheduling request based at least in part on a random selection of the resource from the contention-based resource set, wherein the successful contention-based procedure comprises the random selection of the resource from the contention-based resource set.

11. The apparatus of claim 1, wherein, to transmit the scheduling request, the processor is further configured:
transmit the scheduling request using a cyclic shift that is mapped to a radio network temporary identifier of the UE.

12. The apparatus of claim 1, wherein the plurality of contention-based resource sets are periodic.

13. The apparatus of claim 1, wherein each contention-based resource set of the plurality of contention-based resource sets is associated with a respective logical channel.

14. The apparatus of claim 1, wherein the uplink resources are for an uplink message that comprises a virtual reality uplink message or a ultra-reliable low latency communication uplink message.

15. An apparatus for wireless communication at a network entity, comprising:
a memory; and
a processor coupled to the memory and configured to:
transmit a message indicating a plurality of contention-based resource sets dedicated for scheduling requests for one or more user equipments (UEs), each contention-based resource set of the plurality of contention-based resource sets being associated with one or more respective conditions; and
receive, via a resource of a contention-based resource set of the plurality of contention-based resource sets, a scheduling request that requests uplink resources from a first UE, the contention-based resource set being based at least in part on satisfaction of the one or more respective conditions for the contention-based resource set at the first UE and on a successful contention-based procedure for the contention-based resource set at the first UE.

16. The apparatus of claim 15, wherein, to receive the scheduling request, the processor is further configured to:
receive, via the resource of the contention-based resource set, the scheduling request based at least in part on a remaining packet delay budget of an uplink message associated with the scheduling request being greater than a packet delay threshold, wherein the satisfaction of the one or more respective conditions of the contention-based resource set comprises the remaining packet delay budget of the first UE being greater than the packet delay threshold.

17. The apparatus of claim 15, wherein, to receive the scheduling request, the processor is further configured to:
receive, via the resource of the contention-based resource set, the scheduling request based at least in part on a remaining packet delay budget of an uplink message associated with the scheduling request being greater than a first packet delay threshold and being less than a second packet delay threshold, wherein the satisfaction of the one or more respective conditions of the contention-based resource set comprises the remaining packet delay budget of the first UE being greater than the first packet delay threshold and less than the second packet delay threshold.

18. The apparatus of claim 15, wherein, to receive the scheduling request, the processor is further configured to:
receive, via the resource of the contention-based resource set, the scheduling request based at least in part on a buffer size of the first UE being greater than a buffer size threshold, wherein the satisfaction of the one or more respective conditions of the contention-based resource set comprises the buffer size of the first UE being greater than the buffer size threshold.

19. The apparatus of claim 15, wherein, to receive the scheduling request, the processor is further configured to:
receive, via the resource of the contention-based resource set, the scheduling request based at least in part on a buffer size of the first UE being less than a buffer size threshold, wherein the satisfaction of the one or more respective conditions of the contention-based resource set comprises the buffer size of the first UE being less than the buffer size threshold.

20. The apparatus of claim 15, wherein, to receive the scheduling request, the processor is further configured to:
receive, using the resource of the contention-based resource set, the scheduling request based at least in part on a buffer size of the first UE being greater than a first buffer size threshold and being less than a second buffer size threshold, wherein the satisfaction of the one or more respective conditions of the contention-based resource set comprises the buffer size of the first UE being greater than the first buffer size threshold and less than the second buffer size threshold.

21. The apparatus of claim 15, wherein the processor is further configured to:
transmit an indication of a probability function associated with the plurality of contention-based resource sets, the probability function being based at least in part on a packet delay time of each UE of the one or more UEs, wherein receiving the scheduling request via the resource of the contention-based resource set is based at least in part on a computed probability of the first UE satisfying a probability threshold of the contention-based resource set.

22. The apparatus of claim 15, wherein the processor is further configured to:
transmit an indication of the one or more respective conditions associated with each contention-based resource set of the plurality of contention-based resource sets.

23. The apparatus of claim 15, wherein the processor is further configured to:
transmit a radio resource control message indicating the plurality of contention-based resource sets; and
transmit a layer 1 or layer 2 signal indicating activation of the plurality of contention-based resource sets.

24. The apparatus of claim 15, wherein, to receive the scheduling request, the processor is further configured to:
receive, via the resource of the contention-based resource set, the scheduling request based at least in part on a random selection of the resource from the contention-based resource set by the first UE, wherein the successful contention-based procedure comprises the random selection of the resource from the contention-based resource set by the first UE.

25. The apparatus of claim 15, wherein, to receive the scheduling request, the processor is further configured to:
receive the scheduling request that is associated with a cyclic shift that is mapped to a radio network temporary identifier of the first UE.

26. The apparatus of claim 15, wherein the plurality of contention-based resource sets are periodic.

27. The apparatus of claim 15, wherein each contention-based resource set of the plurality of contention-based resource sets is associated with a respective logical channel.

28. The apparatus of claim 15, wherein the uplink resources are for an uplink message that comprises a virtual reality uplink message or a ultra-reliable low latency communication uplink message.

29. A method for wireless communication at a user equipment (UE), comprising:
receiving a message indicating a plurality of contention-based resource sets dedicated for scheduling requests, each contention-based resource set of the plurality of contention-based resource sets being associated with one or more respective conditions; and
transmitting a scheduling request to request uplink resources for the UE using a resource of a contention-based resource set of the plurality of contention-based resource sets based at least in part on satisfaction of the one or more respective conditions for the contention-based resource set and on a successful contention-based procedure for the contention-based resource set.

30. A method for wireless communication at a network entity, comprising:
transmitting a message indicating a plurality of contention-based resource sets dedicated for scheduling requests for one or more user equipments (UEs), each contention-based resource set of the plurality of contention-based resource sets being associated with one or more respective conditions; and
receiving, via a resource of a contention-based resource set of the plurality of contention-based resource sets, a scheduling request that requests uplink resources from a first UE, the contention-based resource set being based at least in part on satisfaction of the one or more respective conditions for the contention-based resource set at the first UE and on a successful contention-based procedure for the contention-based resource set at the first UE.
